(19) United States
(12) Patent Application Publication
(10) Pub. No.: US 2006/0131832 A1
(43) Pub. Date: Jun. 22, 2006

(54) Vehicle propulsion system

(76) Inventors: Stuart M. Lindsay, Burlington, VT (US); David Winters McMath, Hinesburg, VT (US); Mark P. Walker, Jericho, VT (US)

Correspondence Address: FISH & RICHARDSON PC, P.O. BOX 1022, MINNEAPOLIS, MN, 55440-1022, US

(21) Appl. No.: 11/264,591

(22) Filed: Nov. 1, 2005

Related U.S. Application Data
(60) Provisional application No. 60/635,383, filed on Dec. 8, 2004.

(51) Int. Cl. B62M 1/14

(52) U.S. Cl. 280/249; 280/250.1

(57) ABSTRACT

A human-powered vehicle includes a driven wheel with a cantilevered hub, and a hand-operable crank for vehicle propulsion. In a wheelchair the hand cranks are supported on towers that are lowerable to fit under a desk or table. With the vehicle at rest, cranking motion of the crank in a first rotational direction propels the vehicle forward and cranking motion of the crank in a second rotational direction propels the vehicle backward. With the vehicle in forward motion, cessation of crank rotation allows free rotation of the wheel, and crank torque applied in a sense opposing forward vehicle motion applies a braking force to the wheel. An electric vehicle includes a transmission wheel hub that provides similar functions with an electric drive, such as for a wheelchair.

### CROSS-REFERENCE TO RELATED APPLICATIONS

This application claims priority to U.S. Provisional Application Ser. No. 60/635,383, filed on Dec. 8, 2004, the entire contents of which is incorporated herein by reference.

### TECHNICAL FIELD

This application relates to mobility assistance devices, and more particularly to a hand-operable propulsion system for attachment to a wheeled vehicle for persons with a disability, persons engaged in rehabilitation, as well as able-bodied individuals.

### BACKGROUND

Recent advances in the design and development of manual wheelchairs have resulted in significant improvements in propulsion, steering and stability on varying types of terrain and environments, such as the devices disclosed in U.S. Pat. No. 6,902,177, the contents of which is incorporated herein by reference. While these advances have addressed many of the prevailing issues associated with assisted-mobility devices in an outdoor environment, these advances have not addressed the need for a more compact, multiple-gear, bi-directional propulsion system which by design and function, would allow the operator to easily navigate and propel an assisted mobility device in both an indoor and outdoor environment.

Until now, a push rim wheelchair has prevailed as the most common assisted mobility device for use in an indoor environment. Unfortunately, the design limitations of a push rim wheelchair include several disadvantages: a high incidence of fatigue or strain involving the hand and wrist; an inability to be operated by a rider having limited use of one hand or arm; awkward and inefficient steering and propulsion functions.

A compact, hand-operable propulsion system for attachment to an assisted-mobility device is desired which satisfies a number of the aforementioned functional limitations.

### SUMMARY

According to one aspect of the invention, a human-powered vehicle includes a structural frame, a driven wheel mounted for rotation about an axle secured to a lower portion of the frame, a hand-operable crank manually operable by an operator of the vehicle for vehicle propulsion, and a transmission connecting the crank and wheel, such that motion of the crank is converted to a corresponding motion of the wheel. The axle is affixed to the frame on only one side of the wheel, such that the wheel has a cantilevered hub. Notably, the wheel and crank are interconnected such that with the vehicle at rest, cranking motion of the crank in a first rotational direction propels the vehicle forward and cranking motion of the crank in a second rotational direction propels the vehicle backward, and such that, with the vehicle in forward motion, cessation of crank rotation allows free rotation of the wheel, and crank torque applied in a sense opposing forward vehicle motion applies a braking force to the wheel.

In some embodiments, the transmission includes a coaster brake assembly contained within the cantilevered wheel hub.

In some configurations, the hand-operable crank is rotatable about an axis disposed above the driven wheel. In some such configurations, the transmission includes a coaster brake assembly disposed above the driven wheel and adjacent the crank. In other such configurations, the transmission includes a coaster brake assembly contained within the cantilevered wheel hub.

In some embodiments, the transmission provides multiple gear ratios for propulsion of the vehicle in a forward direction. For example, the transmission may include a planetary gear core disposed within a hub shell connected to the wheel, the gear core engaging the hub shell to drive the hub shell in mutual rotation in only one direction. The hub shell may be disposed above the driven wheel, or the hub shell may be a portion of the driven wheel hub.

In some instances, the hand-operable crank is a push rim disposed outboard of the driven wheel. In some other instances, the hand-operable crank includes a crank handle disposed above the wheel, and preferably extending horizontally and positioned for grasping by someone seated in a seat of the vehicle.

Preferably the vehicle includes two hand-operable cranks operably connected to two corresponding driven wheels and independently and simultaneously operable for vehicle propulsion.

In some embodiments the vehicle includes a seat secured to the frame and positioned to enable the vehicle operator to manually operate the crank while seated in the seat. In some cases, the seat is rotatable and connected to a steerable wheel of the vehicle, such that seat rotation alters a steering angle of the steerable wheel.

In some embodiments, the transmission includes a brake shoe that bears against a surface of a rotatable transmission shell to drive the shell in one rotational direction for propulsion, and a freewheel bearing that permits rotation of the brake shoe in said one rotational direction. The freewheel bearing also transfers braking loads while preventing rotation of the brake shoe in an opposite rotational direction.

In some examples, the transmission also includes a brake cone that engages and deflects the brake shoe against the hub shell to rotate the hub shell and drive the wheel in one rotational direction, in response to an associated cranking motion of the crank with the vehicle at rest.

In some cases the brake shoe is disposed within the cantilevered wheel hub, with the rotatable transmission shell forming a portion of the wheel hub. In such cases the transmission may also include a freewheel bearing cover that transfers the braking loads from the freewheel bearing to the axle, such as by being keyed directly to the outer end of the axle so as to transmit torque.

In some other cases the brake shoe is disposed within a transmission hub shell that rotates about an axis of rotation of the hand crank, the axis of rotation of the hand crank being above the wheel, for example. In such cases, the freewheel bearing preferably has an inner race rotationally coupled to the brake shoe, and an outer race rotationally coupled to the frame.

According to another aspect of the invention, a human-powered vehicle includes a structural frame, a driven wheel having a hub mounted for rotation about an axle secured to a lower portion of the frame, a hand-operable crank manually operable by an operator of the vehicle for vehicle propulsion, and a transmission connecting the crank and wheel, such that motion of the crank is converted to a corresponding motion of the wheel. The vehicle also includes a structural crank tower supporting the crank, the crank tower being rotatable about the wheel axle and releasably securable to the frame to lock the tower in an upright position.

In some embodiments, the crank tower is releasably securable to the frame in multiple rotational positions about the wheel axle. Preferably, the crank is operable to drive the wheel with the tower disposed in each of its multiple rotational positions.

In some instances the vehicle also includes a seat secured to the frame and positioned to enable the vehicle operator to manually operate the crank while seated in the seat. Preferably, the crank tower is lowerable to a position lower than a seating surface of the seat.

For vehicle storage or transport, the wheel, crank and crank tower are preferably readily removable from the vehicle frame as a propulsion unit assembly. For example, the propulsion unit assembly may be secured to the vehicle frame by a quick-release connector releasably securing the axle to the frame.

In some embodiments, the wheel and crank are interconnected such that with the vehicle at rest, cranking motion of the crank in a first rotational direction propels the vehicle forward and cranking motion of the crank in a second rotational direction propels the vehicle backward, and such that, with the vehicle in forward motion, cessation of crank rotation allows free rotation of the wheel, and crank torque applied in a sense opposing forward vehicle motion applies a braking force to the wheel.

In some configurations, the axle is to the frame on only one side of the wheel, such that the hub is cantilevered.

According to a third aspect of the invention, a human-powered vehicle has a structural frame and two driven wheels, each mounted for rotation about an axle secured to a lower portion of the frame, with each axle affixed to the frame only inboard of the wheels, such that each wheel has a cantilevered hub. The vehicle has two hand-operable cranks, each rotatable about an axis disposed above the corresponding driven wheel and manually operable by an operator of the vehicle for vehicle propulsion. Transmissions connect each crank with a corresponding wheel, such that motion of each crank is converted to a motion of its corresponding wheel, and structural crank towers support the cranks above the vehicle frame. Notably, the crank towers are releasably secured to the vehicle frame to lock the tower in an upright position, and are movable by the operator sitting in the seat to a lowered position for wheeling a forward portion of the vehicle under a desk, and movable back to their upright position by the operator sitting in the seat, for propulsion.

According to a fourth aspect of the invention, a vehicle includes a structural frame, a driven wheel having a hub mounted for rotation about an axle secured to a lower portion of the frame, and a brake shoe that bears against a surface of the wheel hub to drive the wheel in one rotational direction for vehicle propulsion. The vehicle also has a freewheel bearing that permits rotation of the brake shoe in that one rotational direction, and transfers braking loads to the frame while preventing rotation of the brake shoe in an opposite rotational direction. A hub driver is rotatable to drive the wheel hub in a first rotational direction, and to drive the brake shoe into torque-carrying engagement with the wheel hub to drive the wheel hub in a second rotational direction. Notably, the axle is affixed to the frame on only one side of the wheel, such that the hub is cantilevered, and braking loads are transferred from the freewheel bearing to the frame through the axle.

In some embodiments the vehicle has a hand-operable crank operably connected to the hub driver and manually operable by an operator of the vehicle for vehicle propulsion.

In some embodiments the vehicle has an electric motor, or other power drive, operably connected to the hub driver for vehicle propulsion.

Preferably, the freewheel bearing and brake shoe are components of a coaster brake assembly connecting the hub driver to the hub such that with the vehicle at rest, rotation of the hub driver in a first rotational direction propels the vehicle forward and rotation of the hub driver in a second rotational direction propels the vehicle backward, and such that, with the vehicle in forward motion, cessation of hub driver rotation allows free rotation of the wheel, and hub driver torque applied in a sense opposing forward vehicle motion applies a braking force to the wheel.

The various vehicle power transmission systems described herein are useful for driving the wheels of several types of vehicles, but are particularly useful for enabling intuitive manual driving, or simplified powered driving, of a wheeled mobility device, such as a wheelchair. The lowerable crank towers can enable an operator of a wheelchair the benefits of above-wheel hand crank placement while still allowing the forward portion of the vehicle to be wheeled under a desk or table, as in a traditional wheelchair not having above-wheel hand cranks. That these concepts can be embodied in wheelchairs having cantilevered wheel hubs can accommodate wider seating while allowing the operator to maneuver through a standard door width, although the cantilevered hub drive system is also seen as applicable to other types of vehicles.

Other features and advantages will be apparent from the description and drawings, and from the claims.

### DESCRIPTION OF DRAWINGS

FIG. 1 is a perspective view of a hand-operable propulsion system with cantilevered multi-speed, internal gear hub incorporating a reverse gear.

FIG. 2 is a front view of a propulsion system with a cantilevered wheel and multi-speed, internal gear hand crank assembly incorporating a reverse drive.

FIG. 3 is a detailed partial sectional view of one portion of the multi-speed, internal gear hand crank assembly incorporating a reverse drive of the propulsion system of FIG. 2.

FIG. 4 is a detailed partial sectional view of the high helix gear selector of FIG. 3.

FIG. 5 is a detailed partial sectional view of a single speed internal gear hand crank assembly incorporating a reverse drive.

FIG. 6 is a partial sectional view of a hand operable crank assembly for the propulsions systems of FIG. 8 and FIG. 10.

FIG. 7 is front view of a propulsion system with a cantilevered wheel and an internal gear wheel hub incorporating a reverse drive.

FIG. 8 is a partial sectional view of a multi-speed, internal gear wheel hub, a quick release assembly and an adjustable tower pivot clamp.

FIG. 9 is a detailed partial sectional view of a multi-speed wheel hub and a quick release assembly.

FIG. 10 is a detailed partial sectional view of a single speed wheel hub and a quick release assembly.

FIG. 11 is a perspective view of an assisted mobility device including the propulsion system of FIG. 1.

FIG. 12 is a right side view of the propulsion system of FIG. 1 in an operational position and in a reclined position.

FIG. 13 is a front view of the right side propulsion system and corresponding attachment points to the frame of the assisted mobility device of FIG. 11.

FIG. 14 is a right side view of the device of FIG. 11, depicting the propulsion system an operational position and a reclined position.

FIG. 15 is a front view of the quick release features of the propulsion system of FIG. 7 in a detached position.

FIG. 16 is a front view of the quick release features of the propulsion system of FIG. 7 in an attached position.

FIG. 17 is a partial sectional view of a push-rim actuated multi-speed wheel hub incorporating reverse drive with a wheel assembly and a quick release assembly.

FIG. 18 is a detailed partial sectional view of a push-rim actuated multi-speed wheel hub incorporating reverse drive.

FIG. 19 is a perspective view of an assisted mobility device including push-rim actuated multi-speed wheel hubs incorporating a reverse drive and a quick release assembly.

FIG. 20 is a front view of propulsion system with cantilevered wheel and internal gear wheel hub incorporating a reverse drive; with crank arm and handle positioned on the mounting pin side of the propulsion tower.

FIG. 21 is a perspective view of an assisted mobility device including the propulsion system of FIG. 1 with the crank arm and the handle positioned on the mounting pin side of the propulsion tower.

FIG. 22 is a detailed perspective view of a double sprocket assembly with drive chain for rear wheel steering of an assisted mobility device.

FIG. 23 is a detailed perspective view of a pulley and cable assembly for seat-actuated steering of an assisted mobility device.

FIG. 24 is a front view of an assisted mobility device depicting one of the two hand crank assemblies in a partial sectional view.

FIG. 25A is a detailed partial sectional view of the right side multi-speed, internal gear hand crank assembly of the device of FIG. 24.

FIG. 25B is a detailed sectional view of the modified coaster brake arm of FIG. 25A.

FIG. 26 shows an electric wheel drive, with an electric motor driving a cantilevered wheel hub.

### DETAILED DESCRIPTION

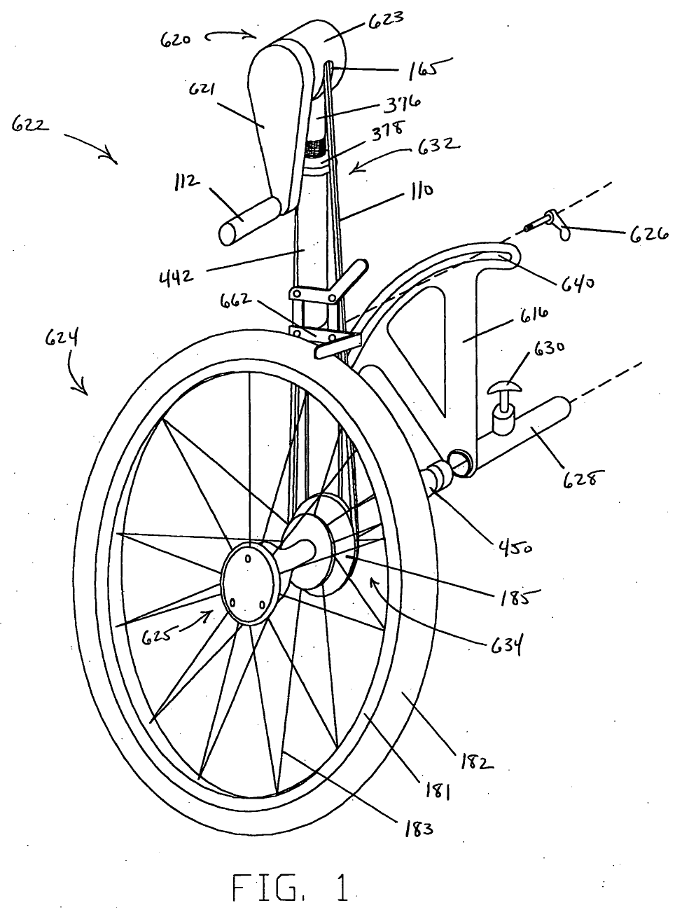

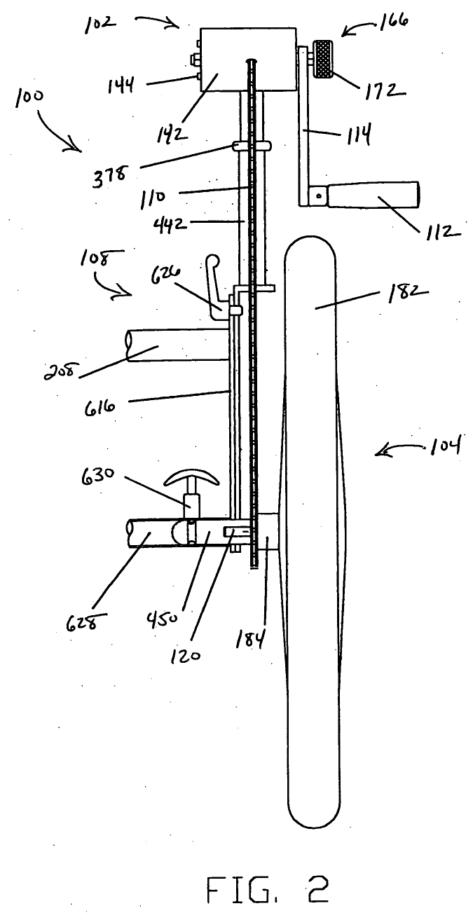

Referring now to FIGS. 1, 2, 3, 4 and 11 and in one embodiment, the propulsion system 100 includes a transmission having one or more independent hand-operable multiple-gear crank assemblies 102, each including a coaster brake assembly 103 operably connected to a corresponding front drive wheel assembly 104 for propulsion and braking of a human powered vehicle 106 in a forward and reverse direction. The hand crank assembly 102 and the front wheel assembly 104 are operably connected by a flexible roller chain 110, for example, and the assemblies 102, 104 are held in position by a propulsion tower assembly 108.

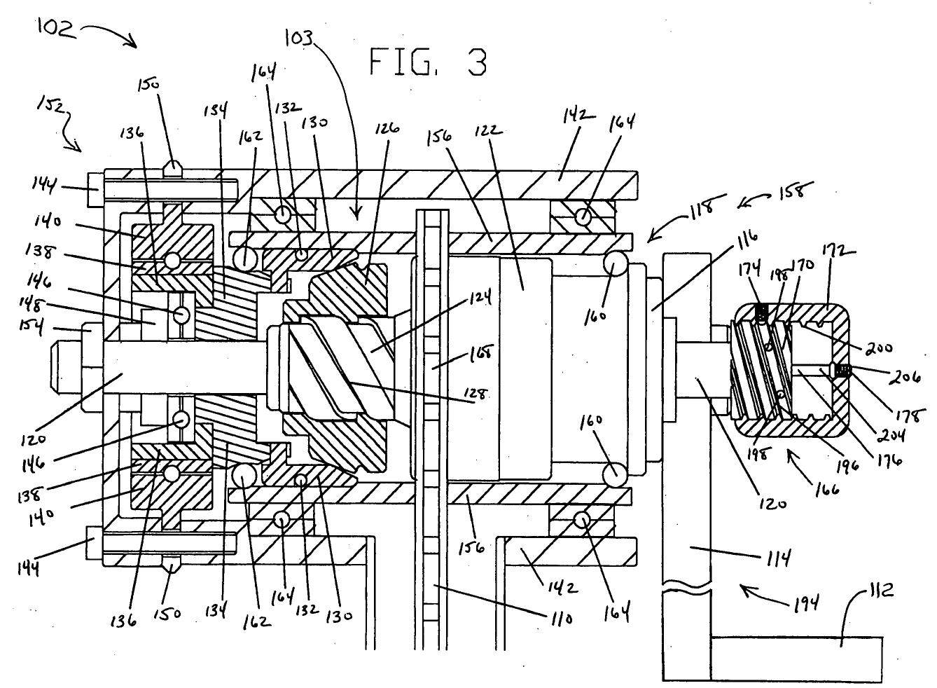

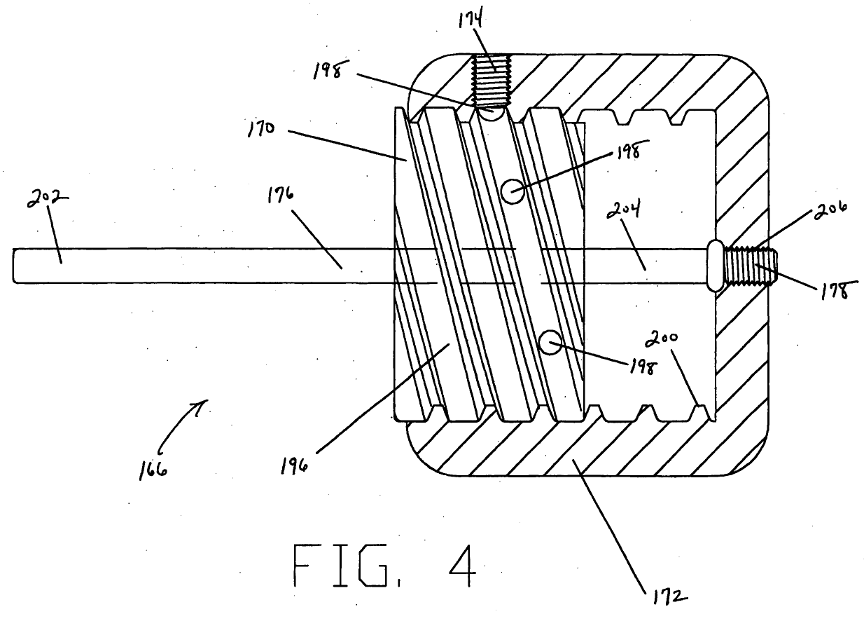

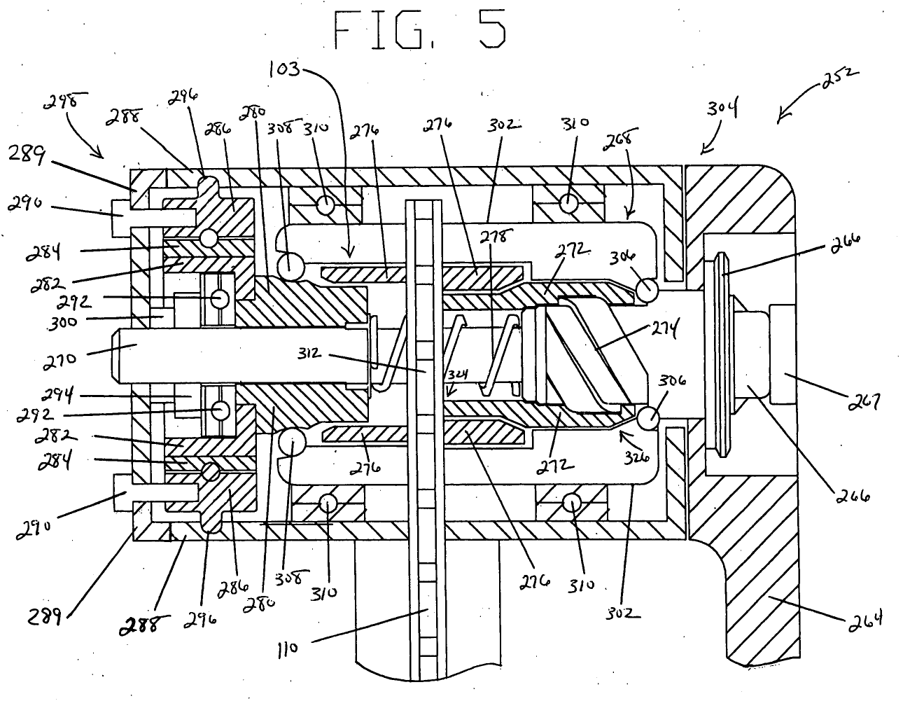

With specific reference to FIG. 3, the hand-operable multi-gear crank assembly 102 includes a crank handle 112, a crank arm 114, a hub driver 116, a hub axle 120, a planetary gear core 122, a brake actuator 124, an inner brake cone 126, actuator threads 128, brake shoes 130, a brake shoe spring 132, an outer brake cone 134, an outer brake cone extension 136, a freewheel bearing 150 with an inner race 138 and an outer race 140, a hub housing 142, retaining bolts 144, a thrust bearing 146, an inner axle nut 148, an outer axle nut 154, a hub shell 156, driver ball bearings 160, brake cone ball bearings 162, hub housing bearing assemblies 164, a gear selector assembly 166 and a drive sprocket 168. As a freewheel bearing, bearing 150 permits relative rotation of its inner and outer races 138, 140 in only one direction, such as a roller clutch bearing. In some embodiments, the coaster brake assembly 103 is sized and configured for containment within the hub housing 142.

The gear selector assembly 166 includes a gear selector body 170, a gear selector cap 172, a ball-nose spring plunger 174, a push rod 176 and a push rod adjuster 178.

The front drive wheel assembly 104 can include a rim 181, tire 182, spokes 183, wheel hub 184, driven sprocket 185 and wheel hub axle 186.

The crank handle 112 is rotatably attached to the crank arm 114, which is affixed to the hub driver 116 of the internal multi-gear coaster brake bicycle hub 118. The hub driver 116 rotates about the axle 120 and drives the planetary gear core 122, which also rotates about axle 120. Planetary gear core 122 includes pawls (not shown) about its outer circumference that engage and drive hub shell 156 only when rotated in one direction with respect to the hub shell 156, but otherwise allow the gear core to rotate freely within the hub shell. Those of ordinary skill in the art will understand the components and operation of a standard multi-gear internal hub planetary transmission. In one embodiment, for example, a Shimano Nexus Inter3 Model No. SG-3C41 Internal Gear Coaster Brake Hub can be used. Affixed to the planetary gear core 122 is the brake actuator 124, which rotates about the axle 120. The inner brake cone 126 is positioned about the brake actuator 124 and engages the helical block threads 128 of the actuator 124. The brake shoes 130 are positioned about the inner brake cone 126. The brake shoes 130 are held in a compressed position by the brake shoe spring 132. The brake shoes 130 are engaged with the outer brake cone 134 such that the position of the brake shoes 130 relative to the position of the outer brake cone 134 remains constant. The outer brake cone 134 is attached to the outer brake cone extension 136. The outer brake cone extension 136 is attached to the inner race 138 of freewheel bearing 150. The outer race 140 of the freewheel bearing is attached to the hub housing 142 with retaining bolts 144, such that braking loads from brake shoes 130 are transferred through the freewheel bearing to the hub housing and the vehicle frame. The thrust bearing 146 is located about the hub axle 120 and within the cavity defined by the freewheel bearing inner race 138, positioned between the outer brake cone extension 136 and the inner axle nut 148. The freewheel bearing 150 is located about the hub axle 120 and within the hub housing 142. On the coaster brake side 152 of the multi-gear hub 118, the hub axle 120 is affixed to the hub housing 142 by the outer axle nut 154 and held in position such that the axle 120 is fixed and is unable to rotate. Driver ball bearings 160 are located between the hub shell 156 and the hub driver 116 on the driver side 158 of the hub. Brake cone ball bearings 162 are located between the hub shell 156 and the outer brake cone 134 on the coaster brake side 152 of the hub.

The multi-gear bicycle hub 118 is rotatably attached within the hub housing 142 and held in position by two hub housing bearing assemblies 164 and affixed to the hub housing 142 by the outer axle nut 154 located on the coaster brake side 152 of the multi-gear hub. A vertical slot 165 is cut into the front and rear lower portion of the hub housing 142 to allow free movement of the flexible roller chain 110.

Referring now to FIGS. 3 and 4, the internal threads of the gear selector body 190 are attached to the threaded hub axle 120 on the crank arm side of the multi-speed hub 194. The gear selector body 170 includes right-hand high helix threads 196 located on the circumferential surface of the gear selector body 170. Two or more detents 198 are located on the crest of the high helix threads 196 of the gear selector body 170. The internal threads of the gear selector cap 200 are engaged upon the high helix threads 196 of the gear selector body 170. A ball-nose spring plunger 174 is affixed within the side wall of the gear selector cap 172 and positioned to engage the detents 198 of the gear selector body 170. The gear selector push rod 176 is located within the hollow cavity of the hub axle 120 at the first end 202 and comes into contact with the push rod adjuster 178 at the second end 204. The push rod adjuster 178 is a headless hex socket set screw located within a threaded hole 206 in the center of the end wall of the gear selector cap 172 and positioned to engage the second end of the push rod 204.

Referring also to FIGS. 1, 2 and 11, affixed to the exterior of the multi-gear hub shell 156 is a drive sprocket 168. Alternative drivers, such as a cog or pulley, for example, can be suitably implemented. Engaged upon the drive sprocket 168 is a chain 110, cogged belt or cable connecting the hub shell 156 at the upper end to a corresponding driven sprocket 185, cog or pulley at the lower end. The driven sprocket 185 is affixed to the wheel hub 184. The wheel hub 184 is rotatably attached to the wheel hub axle 186, which is affixed to the vehicle frame 208. The driven front wheel 180 is affixed to the wheel hub 184. In one example, the gear selector assembly 166 is attached to the multi-gear coaster brake hub axle 120 on the driver side 158 of the multi-gear hub, and is manually operable to move an internal push rod 176 to shift gear engagements within the multi-gear hub 118.

In operation, the rider rotates the crank handle 112 and crank arm 114 in a forward direction to propel the vehicle 106 forward. With the vehicle 106 in a stationary position, the rider rotates the crank handle 112 and the crank arm 114 in a rearward direction to propel the vehicle 106 rearward. With the vehicle 106 moving in a forward direction, the rider rotates the crank handle 112 and crank arm 114 in a rearward direction to slow down and brake the vehicle 106. With the vehicle 106 moving in a rearward direction, the rider rotates the crank handle 112 and the crank arm 114 in a forward direction to slow down and eventually stop the rearward movement of the vehicle 106. In this way, rotating the crank handle 112 and crank arm 114 in a direction opposite to vehicle motion provides an intuitive means of slowing the vehicle 106. In one embodiment, partial rotation of the crank handle 112 and crank arm 114 engages the coaster brake function of the multi-gear hub 118.

The forward rotation of the crank handle 112 and crank arm 114 rotates the multi-gear hub driver 116, which rotates the planetary gear core 122, which engages and rotates the hub shell 156 at a selected ratio with respect to the hub driver 116. Forward rotation of the hub shell 156 rotates the hub shell drive sprocket 168, which drives the chain 110, which rotates the driven sprocket 185 which drives the corresponding front wheel 180, propelling the vehicle 106 in a forward direction.

The rider chooses the desired drive gear of the multi-gear hub 118 using the gear selector cap 172 while the vehicle 106 is stationary or moving forward. In operation, the gear selector cap 172 is rotated in a clockwise or counter-clockwise direction to select the desired gear ratio. When the gear selector cap 172 is rotated in a clockwise direction, the push rod adjuster 178 moves the push rod 176 further into the hollow cavity of the hub axle 120, which causes the planetary gear core 122 to move into a higher gear. When the gear selector cap 172 is rotated in a counter-clockwise direction, the push rod adjuster 178 allows the push rod 176 to move outward from the hollow cavity of the hub axle 120, which causes the planetary gear core 122 to move into a lower gear.

When the gear selector cap 172 is rotated in either direction, the ball nose spring plunger 174 located in the side wall of the gear selector cap 172 engages one detent 198 located on the crest of the high helix thread 196. This engagement holds the gear selector cap 172 in a fixed position, which holds the push rod 176 in a fixed position which maintains the selected gear of the multi-speed internal gear hub 118. When the push rod adjuster 178 is rotated in a clockwise or counter-clockwise direction, the push rod 176 is repositioned within the cavity of the hub axle 120 to accomplish proper alignment for the selected gear. The function of the gear selector components (not shown) within the planetary gear core 122 of a multi-speed internal gear bicycle hub 118 will be understood by those of ordinary skill in this art.

In operation, rearward rotation of the crank handle 112 and crank arm 114 while the vehicle 106 is stationary rotates the multi-gear hub driver 116 in a reverse direction, which causes the planetary gear core 122 to rotate in a reverse direction, which causes the brake actuator 124 to rotate in a reverse direction, which causes the inner brake cone 126 to rotate in a reverse direction and move longitudinally along the brake actuator threads 128 away from the crank handle, which causes the inner brake cone 126 to engage the brake shoes 130, which causes the brake shoes 130 to expand and to engage the hub shell 156, which causes the hub shell 156 to rotate in a reverse direction. The outer brake cone 134 is engaged with the brake shoes 130 and therefore also rotates in a reverse direction. This reverse rotation of the outer brake cone 134 is possible because the outer brake cone 134 is affixed to the outer brake cone extension 136, which is affixed to the inner race of the freewheel bearing 138 which rotates within the outer race of the freewheel bearing 140 which is affixed to the crank hub housing 142.

When the hub shell 156 rotates in a reverse direction, the hub shell drive sprocket 168 drives the chain 110 in a reverse direction, which rotates the driven sprocket 185 in a reverse direction, which drives the corresponding front wheel 180 in a reverse direction.

A partial rearward rotation of the crank handle 112 and crank arm 114 while the vehicle 106 is moving forward rotates the multi-gear hub driver 116 in a reverse direction, which causes the planetary gear core 122 to rotate in a reverse direction, which causes the brake actuator 124 to rotate in a reverse direction, which causes the inner brake cone 126 to travel longitudinally on the actuator threads 128, which causes the inner brake cone 126 to engage the brake shoes 130, which drives the brake shoes 130 into contact with the outer brake cone 134 which causes the brake shoes 130 to expand and to engage the hub shell 156, which introduces resistance to the forward rotation of the hub shell 156. This resistance is transferred from the hub shell 156 to the hub shell drive sprocket 168, which is transferred to the chain 110, which then transfers the resistance to the front wheel assembly 104, which causes the vehicle 106 to slow down or come to a complete stop. In this example, the freewheel bearing 150 prevents the outer brake cone 134 from rotating in a forward direction, which prevents the brake shoes 130 from rotating in a forward direction, which prevents the inner brake cone 126 from rotating in a forward direction, which prevents the planetary gear core 122 from rotating in a forward direction and engaging the multi-gear hub driver 116, which prevents the crank arm 114 from being driven in a forward direction.

It can be further noted that when the operator initiates a transition from moving the vehicle 106 in a reverse direction to moving in a forward direction, the freewheel bearing 150 in combination with the outer brake cone extension 136 prevents the outer brake cone 134 from rotating, as does a coaster brake arm in a traditional coaster brake arrangement. In this example, the forward rotation of the brake actuator 124 causes the inner brake cone 126 to slide longitudinally along the actuator threads 128 toward the planetary gear core 122, causing the inner brake cone 126 to disengage from the brake shoes 130, which causes the brake shoe spring 132 to return the brake shoes 130 to a compressed position, which causes the brake shoes 130 to disengage from the hub shell 156.

This allows the rider to propel the vehicle 106 in a forward direction with a selected gear ratio by rotating the crank handles 112 in a forward direction, freewheel in a forward direction by discontinuing crank rotation, brake the vehicle 106 while moving in the forward direction by partial rotation of the crank handles 112 in a reverse direction, propel the vehicle 106 rearward by rotating the crank handles 112 in a reverse direction, and brake the vehicle 106 while moving in a rearward direction by rotating the crank handles 112 in a forward direction. All of the aforementioned actions are performed while the operator maintains full, uninterrupted contact with the crank handles 112.

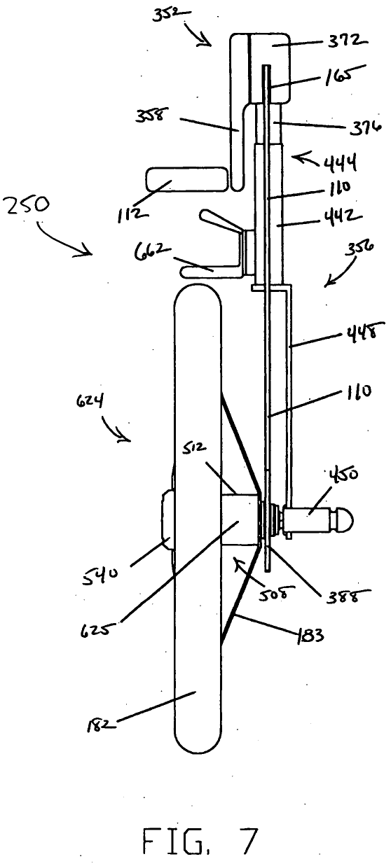

Referring now to FIGS. 1, 5, 7 and 11 and in another embodiment, the propulsion system 250 includes a transmission having one or more independent hand-operable single speed crank assemblies 252, each including a coaster brake assembly 103 operably connected to a corresponding front drive wheel assembly 104 for propulsion and braking of a human powered vehicle 106 in a forward and reverse direction. The hand crank assembly 252 and the front wheel assembly 104 are held in position by a propulsion tower assembly 258 and operably connected by a flexible roller chain 110, for example.

The hand-operable single speed crank assembly 252 includes a crank handle 112, a crank arm 264, a hub driver 266, a driver-side axle nut 267, a hub axle 270, a clutch cone 272, hub driver threads 274, brake shoes 276, clutch cone spring 278, a brake cone 280, a brake cone extension 282, a freewheel bearing 296 with an inner race 284 and an outer race 286, a hub housing 288, a freewheel bearing cover 289, retaining bolts 290, a thrust bearing 292, an inner axle nut 294, an outer axle nut 300, a hub shell 302, driver ball bearings 306, brake cone ball bearings 308, hub housing bearing assemblies 310 and a drive sprocket 312. In some embodiments, the coaster brake assembly 103 is sized and configured for containment within the hub housing 142.

The front drive wheel assembly 104 can include a rim 181, spokes 183, tire 182, wheel hub 184, driven sprocket 185 and wheel hub axle 186.

The crank handle 112 is rotatably attached to the crank arm 264, which is affixed to the hub driver 266 of the internal coaster brake bicycle hub 268. The hub driver 266 rotates about the hub axle 270 and engages the clutch cone 272. In one embodiment, for example, a KT Internal Gear Coaster Brake Hub Model No. KT305 can be used. Those of ordinary skill in this art will understand the components and operation of a standard single speed internal gear bicycle hub. The clutch cone 272 is positioned about the hub driver 266 and engages the helical block threads of the hub driver 274. The brake shoes 276 are positioned about the clutch cone 272 on one end. The brake shoes 276 are engaged with the brake cone 280 at the second end such that the position of the brake shoes 276 relative to the position of the brake cone 280 remains constant. The clutch spring 278 is positioned about the hub axle 270 and at the first end is located within the cavity of the clutch cone 272. At the second end, the clutch spring 278 engages the brake cone 280. The brake cone 280 of the KT coaster brake hub is modified by removing the internal threads of the brake cone 280, thereby allowing free rotation of the brake cone 280 about the hub axle 270. The brake cone 280 is attached to the brake cone extension 282. The brake cone extension 282 is attached to the inner race 284 of freewheel bearing 296. The outer race 286 of the freewheel bearing 296 is attached to the freewheel bearing cover 289 with retaining bolts 290. The thrust bearing 292 is located about the hub axle 270 and within the cavity defined by the freewheel bearing inner race 284, positioned between the brake cone extension 282 and the inner axle nut 294. The freewheel bearing 296 is located about the hub axle 270 and within the hub housing 288. On the coaster brake side 298 of the single speed coaster brake hub, the hub axle 270 is affixed to the hub housing 288 by the outer axle nut 300 and held in position such that the axle 270 is fixed and is unable to rotate. The driver ball bearings 306 are located between the hub shell 302 and the hub driver 266 on the driver side 304 of the hub. The brake cone ball bearings 308 are located between the hub shell 302 and the brake cone 280 on the coaster brake side 298 of the hub.

The modified single speed internal gear bicycle hub 268 is rotatably attached within the hub housing 288 and held in position by two hub housing bearing assemblies 310 and affixed to the hub housing 288 by the outer axle nut 300 located on the coaster brake side 298 of the single speed hub. A vertical slot 165 is cut into the front and rear lower portion of the crank hub housing 288 to allow free movement of the flexible roller chain 110.

A drive sprocket 312 is affixed to the exterior of the single speed hub shell 302. Alternative drivers, such as a cog or pulley (not shown), for example, can be suitably implemented. Engaged upon the drive sprocket 312 is a chain 110, cogged belt or cable connecting the hub shell 302 at the upper end to a corresponding driven sprocket 185, cog or pulley at the lower end. The driven sprocket 185 is affixed to the wheel hub 184. The wheel hub 184 is rotatably attached to the wheel hub axle 186, which is affixed to the vehicle frame 208. The driven front wheel 180 is affixed to the wheel hub 184 with spokes 183.

In operation, the rider rotates the crank handle 112 and crank arm 264 in a forward direction to propel the vehicle 106 forward. With the vehicle 106 in a stationary position, the rider rotates the crank handle 112 and the crank arm 264 in a rearward direction to propel the vehicle 106 rearward. With the vehicle 106 moving in a forward direction, the rider rotates the crank handle 112 and crank arm 264 in a rearward direction to slow down and brake the vehicle 106. With the vehicle 106 moving in a rearward direction, the rider rotates the crank handle 112 and the crank arm 264 in a forward direction to slow down and stop the rearward movement of the vehicle 106. In this way, rotating the crank handle 112 and the crank arm 264 in a direction opposite to vehicle motion provides an intuitive means of slowing the vehicle 106. In one embodiment, partial rotation of the crank handle 112 and crank arm 264 engages the coaster brake function.

In operation, the forward rotation of the crank handle 112 and crank arm 264 rotates the single speed hub driver 266, which rotates the clutch cone 272, which is urged longitudinally toward the crank handle to bear against and rotate the hub shell 302. Rotation of the hub shell 302 rotates the hub shell drive sprocket 312, which drives the chain 110, which rotates the driven sprocket 185, which drives the corresponding front wheel assembly 104, propelling the vehicle 106.

Rearward rotation of the crank handle 112 and crank arm 264 while the vehicle 106 is in a stationary position rotates the single speed hub driver 266 in a reverse direction, which causes the clutch cone 272 to rotate in a reverse direction and travel longitudinally along the hub driver threads 274 away from the crank handle, which causes the clutch cone 272 to engage the brake shoes 276, which drives the brake shoes 276 into contact with the brake cone 280 which causes the brake shoes 276 to expand and to engage the hub shell 302, which causes the hub shell 302 to rotate in a reverse direction. The brake cone 280 is engaged with the brake shoes 276 and therefore also rotates in a reverse direction. This reverse rotation of the brake cone 280 is possible because the brake cone 280 is affixed to the brake cone extension 282, which is affixed to the inner race 284 of the freewheel bearing which rotates within the outer race 286 of the freewheel bearing, which is affixed to the crank hub housing 288.

When the hub shell 302 rotates in a reverse direction, the hub shell drive sprocket 312 drives the chain 110 in a reverse direction, which rotates the driven sprocket 185 in a reverse direction, which drives the corresponding front wheel assembly 104 in a reverse direction.

A partial rearward rotation of the crank handle 112 and crank arm 264 while the vehicle 106 is moving forward rotates the single speed hub driver 266 in a reverse direction, which causes the clutch cone 272 to rotate in a reverse direction and travel longitudinally on the hub driver threads 274 away from the crank handle, which causes the clutch cone 272 to engage the brake shoes 276, which drives the brake shoes 276 into contact with the brake cone 280 which causes the brake shoes 276 to expand and to engage the hub shell 302, which introduces resistance to the forward rotation of the hub shell 302. This resistance is transferred from the hub shell 302 to the hub shell drive sprocket 312, and then transferred to the chain 110, and then transferred to the front wheel assembly 104, which causes the vehicle 106 to slow down or come to a complete stop.

In this example, the outer race 286 of freewheel bearing 296 is attached to the hub housing 288 with retaining bolts 290 which prevents the brake cone 280 from rotating in a forward direction, which prevents the brake shoes 276 from rotating in a forward direction, which prevents the hub shell 302 from rotating in a forward direction, which prevents the clutch cone 272 from rotating in a forward direction, which prevents the hub driver 266 from driving the crank arm 264 in a forward direction.

It can be further noted that when the operator initiates a transition from moving the vehicle 106 in a reverse direction to moving in a forward direction, the freewheel bearing 296 in combination with the brake cone extension 282 prevents the brake cone 280 from rotating. In this example, the forward rotation of the hub driver 266 causes the clutch cone 272 to move longitudinally along the hub driver threads 274 toward the hub driver 266, which causes the clutch cone 272 to disengage from the brake shoes 276, which causes the brake shoes 276 to disengage from the hub shell 302. In this example, the clutch cone spring 278 assists in the longitudinal travel of the clutch cone 272 about the hub driver threads 274.

This allows the rider to propel the vehicle 106 in a forward direction by rotating the crank handles 112 in a forward direction, freewheel in a forward direction by discontinuing crank handle rotation, brake the vehicle 106 while moving in the forward direction by partial rotation of the crank handles 112 in a reverse direction, propel the vehicle 106 rearward by rotating the crank handles 112 in a reverse direction, and brake the vehicle 106 while moving in a rearward direction by rotating the crank handles 112 in a forward direction. All of the aforementioned actions are performed while the operator maintains full, uninterrupted contact with the crank handles 112.

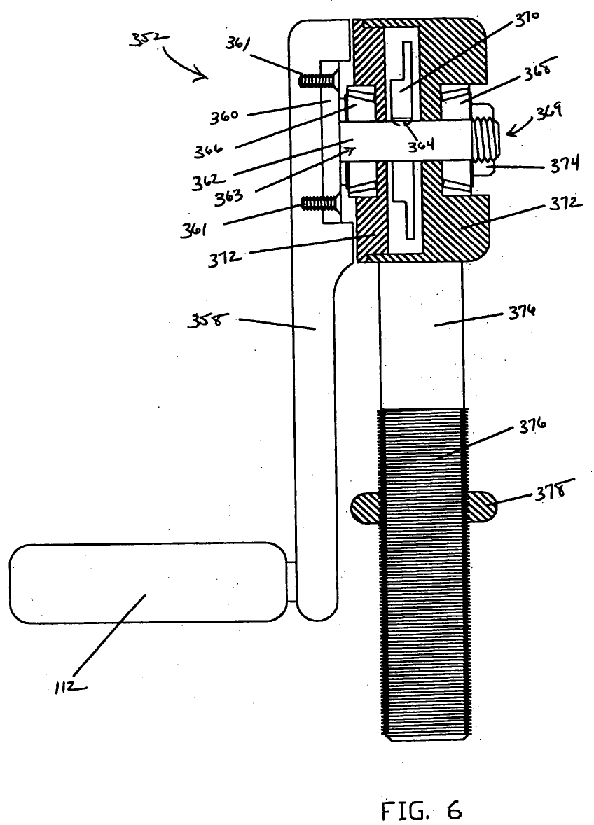

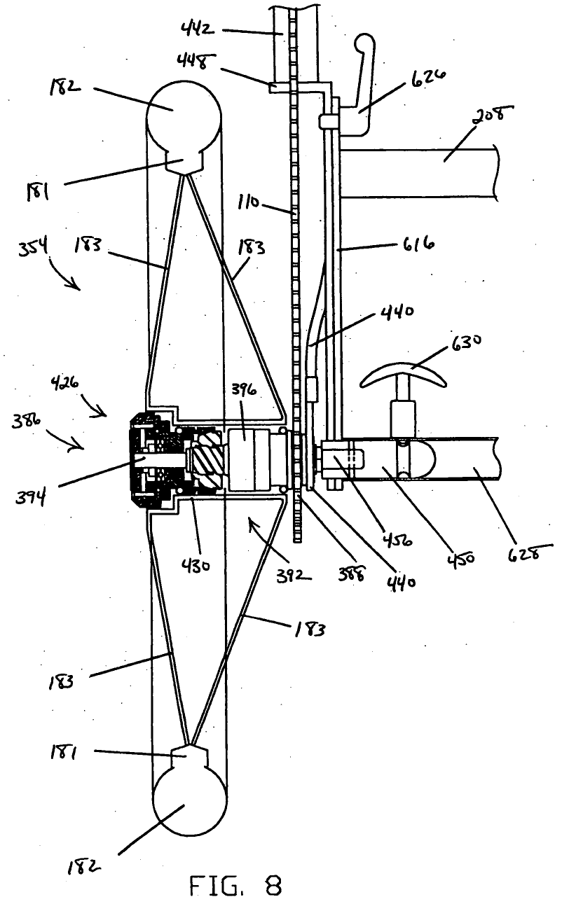

Referring now to the embodiment of FIGS. 6, 7, 8, 9 and 11, propulsion system 350 includes a transmission having one or more independent hand-operable crank assemblies 352, each including a coaster brake assembly 103 operably connected to a corresponding front drive wheel assembly 354 for propulsion and braking of a human powered vehicle 106 in a forward and reverse direction. The hand crank assembly 352 and the front wheel assembly 354 are held in position by a propulsion tower assembly 356 and operably connected by a flexible roller chain 110, for example.

Each hand-operable crank assembly 352 includes a crank handle 112, a crank arm 358, a crank arm mounting plate 360, mounting plate screws 361, a keyed shaft 362, a woodruff key 364, an inner bearing 366, an outer bearing 368, a drive sprocket 370, a crank housing 372, a shaft retaining nut 374, a threaded mounting post 376 and a threaded chain tension adjuster 378.

Each front drive wheel assembly 354 includes a rim 181, spokes 183, a tire 182, a wheel hub assembly 386 and a driven sprocket 388.

Each front wheel hub assembly 386 includes a hub driver 390, a hub axle 394, a planetary gear core 396, a brake actuator 398, an inner brake cone 400, actuator threads 402, brake shoes 404, a brake shoe spring 406, an outer brake cone 408, brake cone extension 410, a freewheel bearing 422 with an inner race 412 and an outer race 414, retaining bolts 416, a thrust bearing 418, an inner axle nut 420, a freewheel bearing cover 424, an outer axle nut 428, a hub shell 430, a hub shell extension 432, driver ball bearings 436, brake cone ball bearings 438, and a gear shifter 440. In some embodiments, the coaster brake assembly 103 is sized and configured for containment within the hub shell 430.

Each propulsion tower assembly 356 includes a vertical receiver tube 442 slotted at the upper end, a collar clamp 446, a tower plate 448 and a horizontal tower mounting pin 450.

The crank handle 112 is rotatably attached to the crank arm 358, which is affixed to the crank arm mounting plate 360 with mounting plate screws 361. The crank arm mounting plate 360 is affixed to the first end of the keyed shaft 363. Mounted about the keyed shaft 362 is a drive sprocket 370 with a broached hub and is held in position by a woodruff key 364. The keyed shaft 362 is rotatably affixed to the crank housing 372 by an inner bearing 366 at the first end 363 and an outer bearing 368 at the second end 369. The keyed shaft 362 is held in position by a retaining nut 374 at the second end 369.

Engaged upon the hand crank drive sprocket 370 is a chain 110, cogged belt or cable connecting the hand crank assembly 352 to a corresponding driven sprocket 388, cog or pulley attached to the front drive wheel assembly 354. The front drive wheel hub assembly 386 is affixed to the propulsion tower mounting pin 450, which is affixed to the vehicle frame 208.

A vertical slot 165 is cut into the front and rear lower portion of the crank housing 372 to allow free movement of the flexible roller chain 110. Affixed to the lower portion of the hand crank housing 372 is a threaded mounting post 376. Rotatably attached to the threaded section of the mounting post 376 is a threaded chain tension adjuster 378.

The hub driver 390 rotates about the hub axle 394 and drives the planetary gear core 396 of an internal gear coaster brake hub 392. Planetary gear core 396 includes pawls (not shown) about its outer circumference that engage and drive hub shell 430 only when rotated in one direction with respect to the hub shell, but otherwise allow the gear core to rotate freely within the hub shell. For example, a Shimano Nexus Inter3 Model No. SG-3C41 Internal Gear Coaster Brake Hub can be used. Those of ordinary skill in this art will be familiar with the components and operation of a standard internal gear coaster brake hub. Affixed to the planetary gear core 396 is the brake actuator 398, which rotates about the hub axle 394. The inner brake cone 400 is positioned about the brake actuator 398 and engages the helical block threads of the actuator 402. The brake shoes 404 are positioned about the inner brake cone 400. The brake shoes 404 are held in a compressed position by the brake shoe spring 406. The brake shoes 404 are engaged with the outer brake cone 408 such that the position of the brake shoes 404 relative to the position of the outer brake cone 408 remains constant. The outer brake cone 408 is attached to the brake cone extension 410. The brake cone extension 410 is attached to the inner race 412 of the freewheel bearing. The outer race 414 of the freewheel bearing is attached to the freewheel bearing cover 424 with retaining bolts 416. The thrust bearing 418 is located about the hub axle 394 and within the cavity defined by the freewheel bearing inner race 412, positioned between the brake cone extension 410 and the inner axle nut 420. The freewheel bearing 422 is located about the hub axle 394 and within the hub shell extension 432. Driver ball bearings 436 are located between the hub shell 430 and the hub driver 390 on the driver side 434 of the hub. Brake cone ball bearings 438 are located between the hub shell 430 and the outer brake cone 408 on the coaster brake side 426 of the hub.

On the coaster brake side 426 of the multi-gear hub, the outer end of fixed hub axle 394 is keyed to freewheel bearing cover 424, such that cover 424 is prevented from rotating. In this example, the outer end of the axle has opposing flats and fits within a slot defined in the inner surface of the bearing cover. Thus, braking loads carried by freewheel bearing 422 are transferred through the freewheel bearing cover through the axle to the vehicle frame, without the need for a reaction arm attached to an outer fork as in a traditional brake coaster arrangement. This enables the combination of bidirectional propulsion, braking and coasting with a cantilevered wheel hub.

The inner end 454 of the hub axle that supports the front drive wheel assembly 354 is a square or hexagonal boss 456 which is received by a corresponding square or hexagonal socket 458 within the first end of the propulsion tower mounting pin 460. The square or hexagonal boss 456 is affixed to the tower mounting pin 460 with a hardened spring pin 462 or dowel pin. This method of affixing the hub axle 394 to the tower mounting pin 450 prevents the rotation of the hub axle 394.

The gear shifter 440 is attached about the hub axle 394 on the driver side 434 of the multi-gear hub, and is manually operable to shift gear engagements within the multi-gear hub 392.

In operation, the rider rotates the crank handle 112 and crank arm 358 in a forward direction to propel the vehicle 106 forward. With the vehicle 106 in a stationary position, the rider rotates the crank handle 112 and the crank arm 358 in a rearward direction to propel the vehicle 106 rearward. With the vehicle 106 moving in a forward direction, the rider rotates the crank handle 112 and crank arm 358 in a rearward direction to slow down and brake the vehicle 106. With the vehicle 106 moving in a rearward direction, the rider rotates the crank handle 112 and the crank arm 358 in a forward direction to slow down and stop the rearward movement of the vehicle 106. Rotating the crank handle 112 and crank arm 358 in a direction opposite to vehicle motion provides an intuitive means of slowing the vehicle 106.

In operation, the forward rotation of the crank handle 112 and crank arm 358 rotates the crank arm mounting plate 360, which rotates the keyed shaft 362, which rotates the drive sprocket 370, which drives the flexible roller chain 110 in a forward direction, which rotates the driven sprocket 388, which rotates the multi-gear hub driver 390, which rotates the planetary gear core 396, which engages and rotates the hub shell 430 in a forward direction at a selected ratio with respect to the hub driver 390. Rotation of the hub shell 430 rotates the front drive wheel assembly 354, which propels the vehicle 106 forward.

The rider can choose the desired drive gear of the multi-gear hub 392 using a standard bicycle gear selector (not shown) while the vehicle 106 is stationary or moving forward. This may be any style of gear selector provided by the multi-gear wheel hub manufacturer or other suppliers.

In operation, rearward rotation of the crank handle 112 and crank arm 358 while the vehicle 106 is in a stationary position rotates the crank arm plate 360, which rotates the keyed shaft 362, which rotates the drive sprocket 370, which drives the flexible roller chain 110, which rotates the driven sprocket 388, which rotates the multi-gear hub driver 390, which rotates the planetary gear core 396 in a reverse direction, which rotates the brake actuator 398 in a reverse direction, which causes the inner brake cone 400 to travel longitudinally on the actuator threads 402 toward the outer brake cone 408, which causes the inner brake cone 400 to engage the brake shoes 404, which causes the brake shoes 404 to expand and to engage the hub shell 430, which causes the hub shell 430 to rotate in a reverse direction. The outer brake cone 408 is engaged with the brake shoes 404 and therefore also rotates in a reverse direction. This reverse rotation of the outer brake cone 408 is possible because the outer brake cone 408 is affixed to the brake cone extension 410, which is affixed to the inner race 412 of the freewheel bearing 422, which rotates within the outer race 414 of the freewheel bearing.

When the hub shell 430 rotates in a reverse direction, the front drive wheel assembly 354 rotates in a reverse direction, which drives the vehicle 106 in a rearward direction.

A partial reverse rotation of the crank handle 112 and crank arm 358 while the vehicle 106 is moving forward rotates the drive sprocket 370 in a reverse rotation, which drives the chain 110 in a reverse direction, which rotates the driven sprocket 388 in a reverse direction, which causes the planetary gear core 396 to rotate in a reverse direction, which causes the brake actuator 398 to rotate in a reverse direction, which causes the inner brake cone 400 to travel longitudinally on the actuator threads 402 toward the outer brake cone 408, which causes the inner brake cone 400 to engage the brake shoes 404, which causes the brake shoes 404 to expand and to engage the hub shell 430, which introduces resistance to the forward rotation of the hub shell 430. This resistance is transferred from the hub shell 430 to the front drive wheel assembly 354, which causes the vehicle 106 to slow down or come to a complete stop.

In this example, the outer race 414 of the freewheel bearing is affixed to the freewheel bearing cover 424, which is affixed to the second end of the axle 466, which prevents the outer brake cone 408 from rotating in a forward direction, which prevents the brake shoes 404 from rotating in a forward direction, which prevents the hub shell 430 from rotating in a forward direction, which prevents the planetary gear core 396 from rotating in a forward direction, which prevents the hub driver 390 from driving the chain 110 in a forward direction, which prevents the crank arm 358 from rotating in a forward direction.

It can be further noted that when the operator initiates a transition from moving the vehicle 106 in a reverse direction to moving in a forward direction, the freewheel bearing 422 in combination with the brake cone extension 410 prevents the outer brake cone 408 from rotating. In this example, the forward rotation of the brake actuator 398 causes the inner brake cone 400 to slide longitudinally along the actuator threads 402 toward the planetary gear core 396, which causes the inner brake cone 400 to disengage from the brake shoes 404, which causes the brake shoe spring 406 to return the brake shoes 404 to a compressed position, which causes the brake shoes 404 to disengage from the hub shell 430.

This allows the rider to propel the vehicle 106 in a forward direction with a selected gear ratio by rotating the crank handles 112 in a forward direction, freewheel in a forward direction by discontinuing crank rotation, brake the vehicle 106 while moving in the forward direction by partial rotation of the crank handles 112 in a reverse direction, propel the vehicle 106 rearward by rotating the crank handles 112 in a reverse direction, and brake the vehicle 106 while moving in a rearward direction by rotating the crank handles 112 in a forward direction. All of the aforementioned actions are performed while the operator maintains full, uninterrupted contact with the crank handles 112.

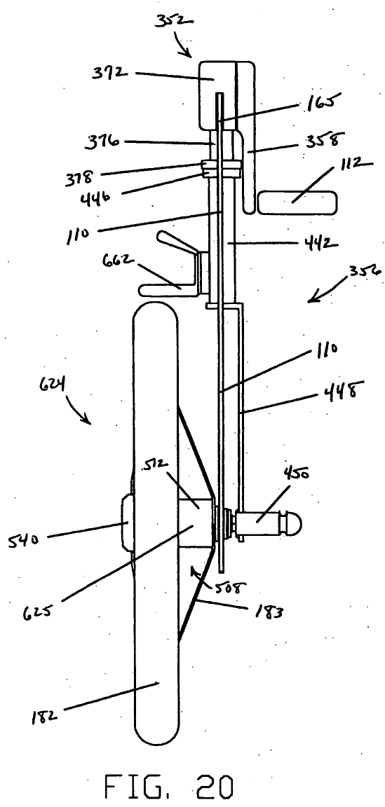

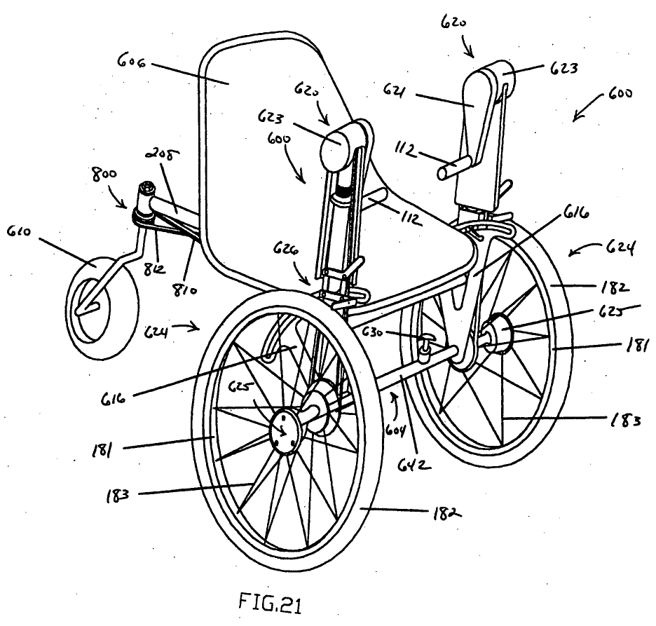

Referring now to FIGS. 1, 6, 7, 10, 11, 20 and 21, propulsion system 500 includes a transmission having one or more independent hand-operable crank assemblies 352, each including a coaster brake assembly 103 operably connected to a corresponding front drive wheel assembly 504 for propulsion and braking of a human powered vehicle 106 in a forward and reverse direction. The hand crank assembly 352 and the front drive wheel assembly 504 are held in position by a propulsion tower assembly 356 and operably connected by a flexible roller chain 110, for example.

Each hand-operable crank assembly 352 includes a crank handle 112, a crank arm 358, a crank arm mounting plate 360, mounting screws 361, a keyed shaft 362, a woodruff key 364, an inner bearing 366, an outer bearing 368, a drive sprocket 370, a crank housing 372, a shaft retaining nut 374, a threaded mounting post 376 and a threaded chain tension adjuster 378.

Each front drive wheel assembly 504 includes a rim 181, spokes 183, a tire 182, a wheel hub assembly 508 and a driven sprocket 388.

Each front wheel hub assembly 508 includes a hub driver 510, a hub axle 514, a clutch cone 516, hub driver threads 518, brake shoes 520, a clutch cone spring 522, a brake cone 524, brake cone extension 526, a freewheel bearing 538 having an inner race 528 and an outer race 530, retaining bolts 532, a thrust bearing 534, an inner axle nut 536, a freewheel bearing cover 540, an outer axle nut 544, a hub shell 546, a hub shell extension 548, driver ball bearings 552, and brake cone ball bearings 554. In some embodiments, the coaster brake assembly 103 is sized and configured for containment with the hub shell 546.

Each propulsion tower assembly 356 includes a vertical receiver tube 442 slotted at the upper end 444, a collar clamp 446, a tower plate 448 and a horizontal tower mounting pin 450.

The crank handle 112 is rotatably attached to the crank arm 358, which is affixed to the crank arm mounting plate 360 with mounting screws 361. The crank arm mounting plate 360 is affixed to the first end of the keyed shaft 363. Mounted about the keyed shaft 362 is a drive sprocket 370 with a broached hub, which is held in position by a woodruff key 364. The keyed shaft 362 is rotatably attached to the crank housing 372 by an inner bearing 366 at the first end 363 and an outer bearing 368 at the second end 369. The keyed shaft 362 is held in position by a retaining nut 374 at the second end 369.

Engaged upon the hand crank drive sprocket 370 is a chain 110, cogged belt or cable connecting the hand crank assembly 352 to a corresponding driven sprocket 388, cog or pulley attached to the front drive wheel assembly 504. The front drive wheel hub assembly 508 is affixed to the propulsion tower mounting pin 450, which is affixed to the vehicle frame 208.

A vertical slot 165 is cut into the front and rear lower portion of the hand crank housing 372 to allow free movement of the flexible roller chain 110.

Affixed to the lower portion of the hand crank housing 372 is a threaded mounting post 376. Rotatably attached to the threaded section of the mounting post 376 is a threaded chain tension adjuster 378.

The hub driver 510 rotates about the hub axle 514 and engages the clutch cone 516 of a single speed internal gear coaster brake hub 512. For example, a KT Model No. KT-305 Internal Gear Coaster Brake Hub can be used. Those of ordinary skill in this art will be familiar with the components and operation of a standard internal gear coaster brake hub. The clutch cone 516 is positioned about the hub driver 510 and engages the helical block threads of the hub driver 518. The brake shoes 520 are positioned about the clutch cone 516 at the first end. The brake shoes 520 are engaged with the brake cone 524 at the second end such that the position of the brake shoes 520 relative to the position of the brake cone 524 remains constant. The clutch cone spring 522 is positioned about the hub axle 514 and at the first end is located within the cavity of the clutch cone 516. At the second end, the clutch cone spring 522 engages the brake cone 524. The brake cone 524 of the KT coaster brake hub, for example, is modified by removing the internal threads of the brake cone 524, thereby allowing free rotation of the brake cone 524 about the hub axle 514. The brake cone 524 is attached to the brake cone extension 526. The brake cone extension 526 is attached to the inner race 528 of the freewheel bearing 538. The outer race 530 of the freewheel bearing is attached to the freewheel bearing cover 540 with retaining bolts 532. The thrust bearing 534 is located about the hub axle 514 and within the cavity defined by the freewheel bearing inner race 528, positioned between the brake cone extension 526 and the inner axle nut 536. The freewheel bearing 538 is located about the hub axle 514 and within the hub shell extension 548. On the coaster brake side 542 of the single speed hub, the hub axle 514 terminates at a position within the freewheel bearing cover 540. Driver ball bearings 552 are located between the hub shell 546 and the hub driver 510 on the driver side 550 of the hub. Brake cone ball bearings 554 are located between the hub shell 546 and the brake cone 524 on the coaster brake side 542 of the hub.

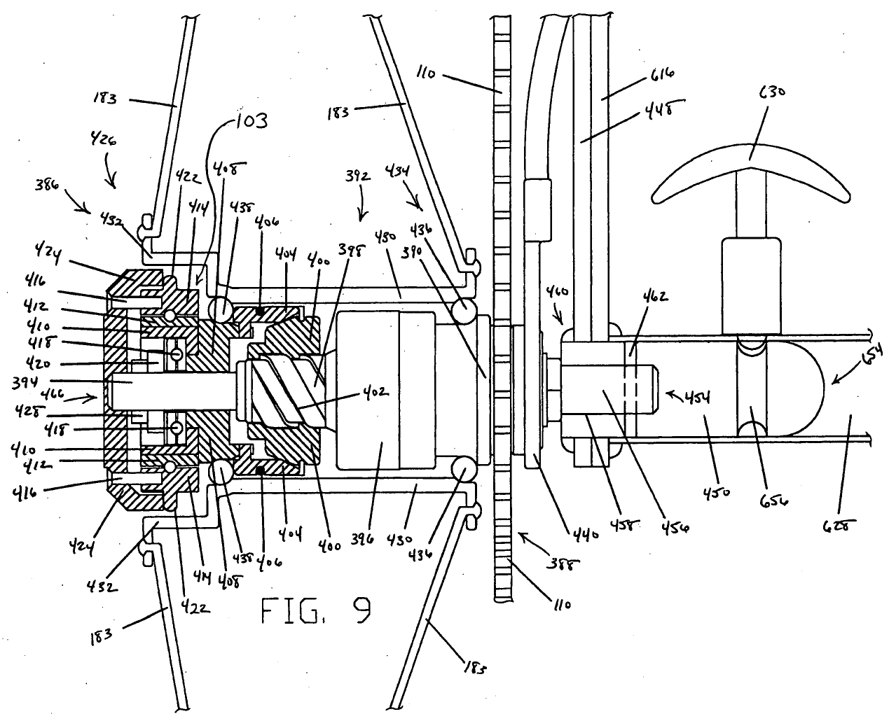

As in the embodiment of FIG. 9, the outer end of hub axle 514 is rotationally keyed to the freewheel bearing cover 540, such that the cover is prevented from rotating. Thus, braking loads carried by freewheel bearing 422 are transferred through the freewheel bearing cover through the axle to the vehicle frame, without the need for a reaction arm attached to an outer fork as in a traditional brake coaster arrangement. This enables the combination of bidirectional propulsion, braking and coasting with a cantilevered wheel hub.

The other end 570 of the hub axle that supports the cantilevered hub of the front drive wheel assembly 504 is a square or hexagonal boss 572 which is received by a corresponding square or hexagonal socket 458 within the first end 460 of the propulsion tower mounting pin. The square or hexagonal boss 572 is affixed to the tower mounting pin 450 with a hardened spring pin 462 or dowel pin. This method of affixing the hub axle 514 to the tower mounting pin 450 prevents the rotation of the hub axle 514.

In operation, the rider rotates the crank handle 112 and crank arm 358 in a forward direction to propel the vehicle 106 forward. With the vehicle 106 in a stationary position, the rider rotates the crank handle 112 and the crank arm 358 in a reverse direction to propel the vehicle 106 rearward. With the vehicle 106 moving in a forward direction, the rider rotates the crank handle 112 and crank arm 358 in a reverse direction to slow down and brake the vehicle 106. With the vehicle 106 moving in a rearward direction, the rider rotates the crank handle 112 and the crank arm 358 in a forward direction to slow down and stop the rearward movement of the vehicle 106. Rotation of the crank handle 112 and crank arm 358 in a direction opposite to the vehicle motion provides an intuitive means of slowing the vehicle 106.

The forward rotation of the crank handle 112 and crank arm 358 rotates the crank arm mounting plate 360, which rotates the keyed shaft 362, which rotates the drive sprocket 370, which drives the flexible roller chain 110 or cogged belt, which rotates the driven sprocket 388, which rotates the single speed hub driver 510, which rotates the clutch cone 516, which rotates the hub shell 546. Rotation of the hub shell 546 rotates the front drive wheel assembly 504, which propels the vehicle 106 forward.

Rearward rotation of the crank handle 112 and crank arm 358 while the vehicle 106 is in a stationary position rotates the crank arm mounting plate 360 in a reverse direction, which rotates the keyed shaft 362, which rotates the drive sprocket 370, which drives the flexible roller chain 110 or cogged belt in a reverse direction, which rotates the driven sprocket 388 in a reverse direction, which rotates the hub driver 510, which rotates the clutch cone 516 in a reverse direction. This causes the clutch cone 516 to travel on the hub driver threads 518 toward the brake cone 524, which causes the clutch cone 516 to engage the brake shoes 520, which causes the brake shoes 520 to expand and to engage the hub shell 546, which causes the hub shell 546 to rotate in a reverse direction. The brake cone 524 is engaged with the brake shoes 520 and therefore also rotates in a reverse direction. This reverse rotation of the brake cone 524 is possible because the brake cone 524 is affixed to the brake cone extension 526, which is affixed to the inner race 528 of the freewheel bearing 538, which rotates within the outer race 530 of the freewheel bearing. In this example, the clutch spring 522 is compressed by the lateral movement of the clutch cone 516 at the first end 562 and the fixed position of the brake cone 524 at the second end 564.

When the hub shell 546 rotates in a reverse direction, the front drive wheel assembly 504 rotates in a reverse direction, which drives the vehicle 106 in a rearward direction.

A partial rearward rotation of the crank handle 112 and crank arm 358 while the vehicle 106 is moving forward drives the chain 110 in a reverse direction, which rotates the driven sprocket 388 in a reverse direction, which causes the hub driver 510 to rotate in a reverse direction, which causes the clutch cone 516 to travel longitudinally on the hub driver threads 518 toward the brake cone 524, which causes the clutch cone 516 to engage the brake shoes 520, which causes the brake shoes 520 to expand and to engage the hub shell 546, which introduces resistance to the forward rotation of the hub shell 546. This resistance is transferred from the hub shell 546 to the front drive wheel 574, which causes the vehicle 106 to slow down or come to a complete stop.

In this example, the outer race 530 of the freewheel bearing 538 is affixed to the freewheel bearing cover 540, which is affixed to the second end 568 of the axle. The freewheel bearing 538 prevents the brake cone 524 from rotating in a forward direction, which prevents the brake shoes 520 from rotating in a forward direction, which prevents the hub shell 546 from rotating in a forward direction, which prevents the clutch cone 516 from rotating in a forward direction, which prevents the hub driver 510 from engaging the chain 110 in a forward direction, which prevents the crank arm 358 from rotating in a forward direction.

It can be further noted that when the operator initiates a transition from moving the vehicle 106 in a reverse direction to moving in a forward direction, the freewheel bearing 538 in combination with the brake cone extension 526 prevents the brake cone 524 from rotating. In this example, the forward rotation of the hub driver 510 causes the clutch cone 516 to travel longitudinally along the hub driver threads 518 toward the driven sprocket 388, which causes the clutch cone 516 to disengage from the brake shoes 520, which causes the brake shoes 520 to disengage from the hub shell 546. During this process, the outer edge of clutch cone spring 522, which is prevented from rotating due to its connection to the brake cone, drags against the inner surface of the clutch cone, assisting to drive the clutch cone along the threads of hub driver 510 toward the sprocket. The operation of the clutch cone spring is as is known in the art of bicycle hub design.

This allows the rider to propel the vehicle 106 in a forward direction by rotating the crank handles 112 in a forward direction, freewheel in a forward direction by discontinuing crank rotation, brake the vehicle 106 while moving in the forward direction by partial rotation of the crank handles 112 in a reverse direction, propel the vehicle 106 rearward by rotating the crank handles 112 in a reverse direction, and brake the vehicle 106 while moving in a rearward direction by rotating the crank handles 112 in a forward direction. All of the aforementioned actions are performed while the operator maintains full, uninterrupted contact with the crank handles 112.

Any of the aforementioned propulsion systems may be attached to a human powered vehicle, and more specifically to an assisted mobility device as described in U.S. Pat. No. 6,902,177.

Referring to FIG. 11, human powered vehicle 106 includes a structural frame 208, two front wheels 602 mounted to a forward portion of the frame 604 for rotation, a seat 606 secured to the frame 208, the seat 606 positioned between the front wheels 602 and adapted to pivot about a seat pivot axis 608, and a steerable rear wheel 610 mounted to the frame 208 behind the seat 606 and defining a rear wheel king pin axis 612, the rear wheel 610 operably linked to the seat 606 such that pivoting of the seat 606 about the seat pivot axis 608 causes pivoting of the rear wheel 610 about the kingpin axis 612 to steer the vehicle 106.

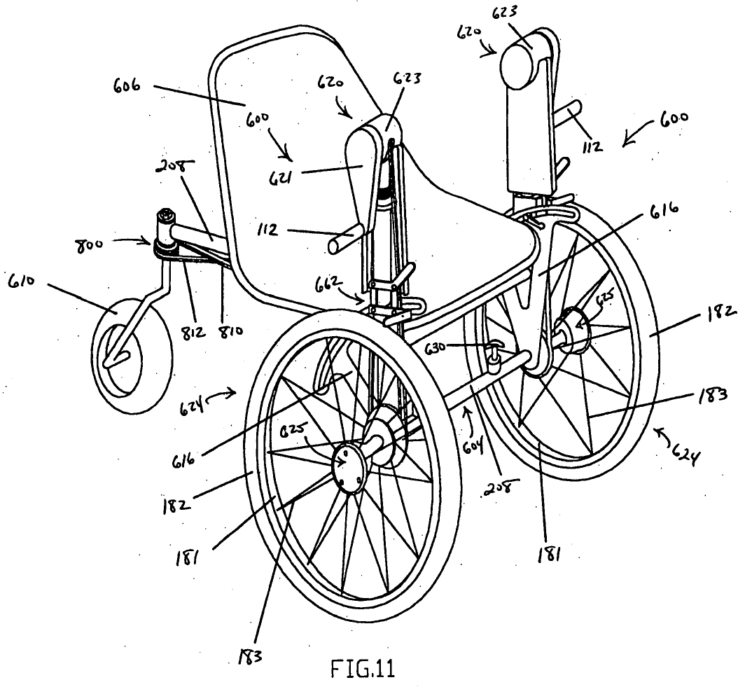

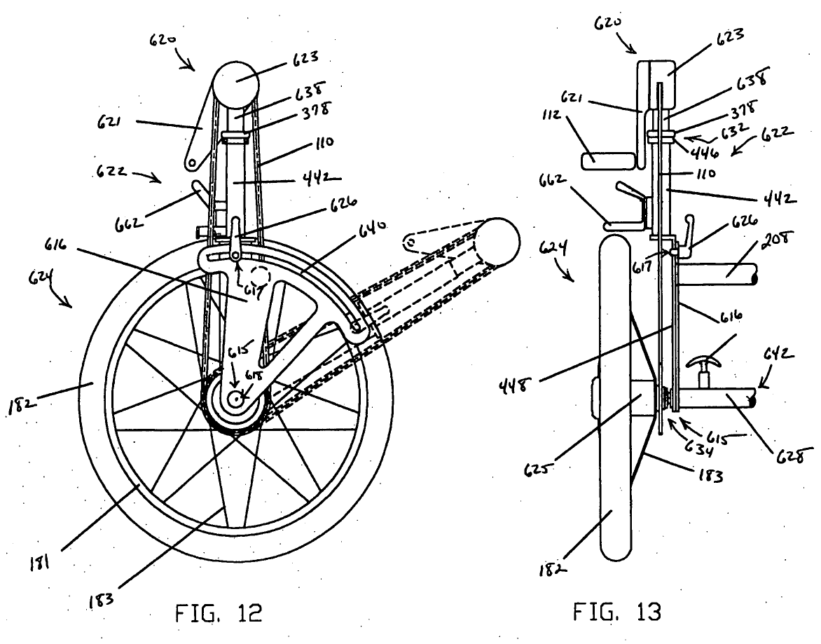

Referring also to FIGS. 1, 12, 13, and 14, the propulsion system is rotatably attached to the lower horizontal frame tube 642 of the human powered vehicle 106 at the lower attachment point 615 and attached to the tower adjustment plate 616 at the upper attachment point 617, such that the propulsion system can be rotated about the pivot axis 618 into multiple positions forward and aft of a vertical position while maintaining the operable connection between the hand crank assembly 620 and the corresponding front drive wheel assembly 624 of any of the aforementioned propulsion systems. In this example the propulsion system is attached to an assisted mobility device as described in U.S. Pat. No. 6,902,177. In some embodiments, the upper portion of the propulsion system can be rotated rearward about the pivot axis 618 to permit an operator seated in the human powered vehicle 106 to roll the forward portion of the vehicle underneath a standard table, desk or work surface 627 (shown in outline), positioned at a height of between about 28 to 34 inches from the floor.

Each of the aforementioned propulsion systems include a hand operable crank assembly 620, a propulsion tower assembly 622, a front drive wheel assembly 624, a flexible roller chain 110 or cogged belt, a tower adjustment plate 616, an adjustable clamping handle 626, a propulsion tower pin receiver 628 and a spring loaded retractable plunger 630.

Each of the aforementioned hand operable crank assemblies 620 includes a crank handle 112, a crank arm 621, a crank housing 623, a vertical slot 165, a mounting post 376 and a chain tension adjuster 378.

Each of the aforementioned drive wheel assemblies 624 includes a rim 181, tire 182, spokes 183, wheel hub 625 and driven sprocket 185.

The hand operable crank assembly 620 is affixed to the upper end of the propulsion tower assembly 622. The front drive wheel assembly 624 is affixed to the lower end of the propulsion tower assembly 622. The flexible roller chain 110 operably connects the hand crank assembly 620 and the front drive wheel assembly 624. The tower adjustment plate 616 is affixed to a forward portion of the frame of the vehicle 636 and includes a curved slot 640. The adjustable clamping handle 626 is rotatably attached to a threaded portion of the propulsion tower assembly 638 and located within the curved slot 640 of the tower adjustment plate 616. The propulsion tower pin receiver 628 is an integral portion of the lower horizontal frame tube 642 of the vehicle frame 208. The spring loaded retractable plunger 630 is affixed to the lower horizontal frame tube 642.

In operation, the propulsion system is secured to the tower adjustment plate 616 with the adjustable clamping handle 626 at the first end and secured to the propulsion tower pin receiver 628 with the spring loaded retractable plunger 630 at the second end.

The propulsion system is rotatably adjusted in a forward or rearward direction by loosening the adjustable clamping handle 626 and rotating the propulsion system to the desired position. The propulsion system pivots within the propulsion tower pin receiver 628. Retightening the adjustable clamping handle 626 secures the propulsion tower assembly 622 to the tower adjustment plate 616 in the position advantageous for the vehicle user.

In operation, the propulsion tower assembly 622 can be rotated in a rearward direction to a position behind and below the seat 606 when such a position may be advantageous to the vehicle user. For example, this may include working at a desk or conference table, or for compact transport of the vehicle 106.

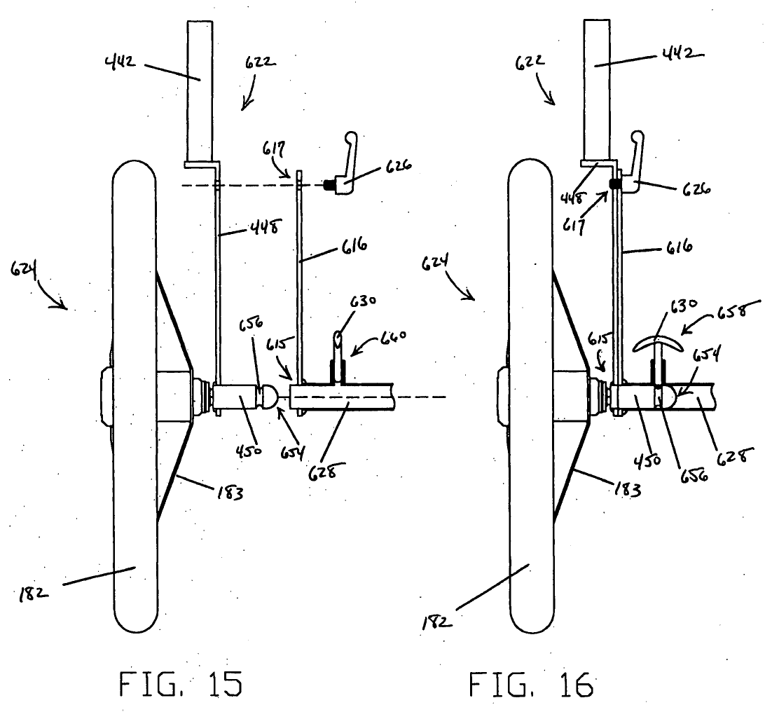

Referring now to FIGS. 15 and 16, the propulsion system is attached to the tower adjustment plate 616 of the vehicle frame 208 with the adjustable clamping handle 626 at the upper attachment point 617, and attached to the propulsion tower pin receiver 628 of the vehicle frame 208 with the spring loaded retractable plunger 630 at the lower attachment point 615 such that the propulsion system can be attached and detached from the vehicle frame 208 in a simple operation referred to as “quick release” in bicycle terminology. Each of the aforementioned propulsion systems includes a hand operable crank assembly 620, a propulsion tower assembly 622, a front drive wheel assembly 624, a flexible roller chain 110 or cogged belt, a tower adjustment plate 616, an adjustable clamping handle 626, a propulsion tower pin receiver 628 and a spring loaded retractable plunger 630. The propulsion tower assembly 622 includes a vertical receiver tube 442, a collar clamp 446, a tower plate 448, and a horizontal tower mounting pin 450. The horizontal tower mounting pin 450 includes a tapered end 654 and a circumferential concave groove 656.

The hand operable crank assembly 620 is affixed to the upper end of the propulsion tower assembly 632. The front drive wheel assembly 624 is affixed to the lower end of the propulsion tower assembly 634. The flexible roller chain 110 operably connects the hand crank assembly 620 and the front drive wheel assembly 624. The tower adjustment plate 616 is affixed to a forward portion of the frame 636 of the vehicle 106 and includes a curved slot 640. The adjustable clamping handle 626 is rotatably attached to a threaded portion of the propulsion tower assembly 638 and located within the curved slot 640 of the tower adjustment plate 616. The propulsion tower pin receiver 628 is an integral portion of the lower horizontal frame tube 642 of the vehicle frame 208. The locking retractable spring plunger 630 is affixed to the lower horizontal frame tube 642. The vertical receiver tube 442 of the propulsion tower assembly 622 is affixed to the tower plate 448. The tower plate 448 is affixed to the horizontal tower mounting pin 450. The horizontal tower mounting pin 450 includes a tapered end 654 and a circumferential concave groove 656 which is positioned to receive the retractable spring plunger 630.

In operation, each of the aforementioned propulsion systems is secured to the tower adjustment plate 616 with the adjustable clamping handle 626 at the upper attachment point 617 and secured to the propulsion tower pin receiver 628 with the locking retractable spring plunger 630 at the lower attachment point 615.

The propulsion system is detached from the vehicle frame 208 by removing the adjustable clamping handle 626 and retracting the locking retractable spring plunger 630. The propulsion system is then detached from the vehicle frame 208 by sliding the propulsion tower mounting pin 450 out of the propulsion tower pin receiver 628.

To reattach the propulsion system, the locking retractable spring plunger 630 is released into the engaged position 658 and the propulsion tower mounting pin 450 is inserted into the propulsion tower pin receiver 628. This engages the spring plunger 630 with the circumferential groove 656 of the propulsion tower mounting pin 450. The adjustable clamping handle 626 is reattached to the threaded portion of the propulsion tower assembly 638 to secure the propulsion system to the vehicle frame 208.

Retightening the adjustable clamping handle 626 secures the propulsion tower assembly 622 to the tower adjustment plate 616 in the position advantageous for the vehicle user.

In operation, the propulsion system can be detached from the vehicle frame 208 for the ease and convenience of transport by the rider or an assistant.

Referring back to FIG. 1, a wheelchair-type locking brake 662 is mounted to the propulsion tower assembly 622 for immobilizing the vehicle 106. When engaged, the brake 662 makes contact with the corresponding front tire 182 of the front wheel assembly 624, thereby preventing rotation of the front wheel assembly 624.

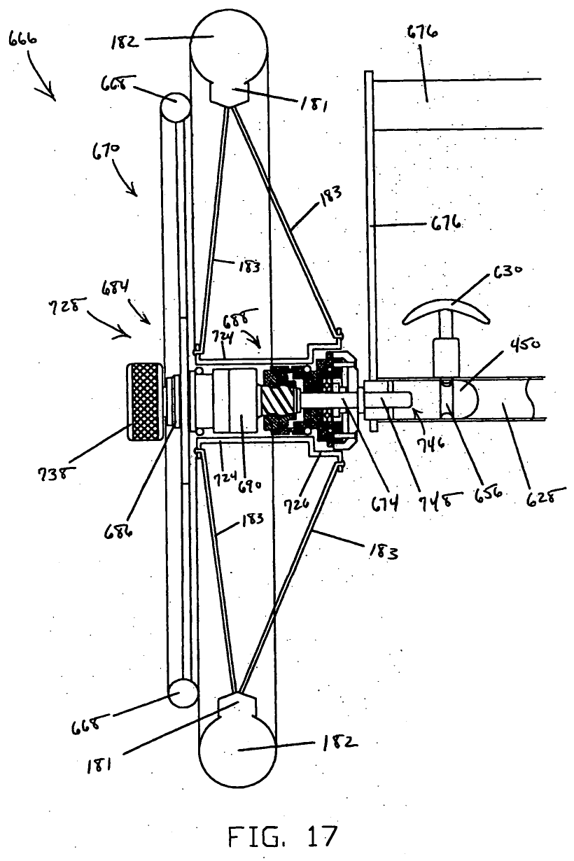

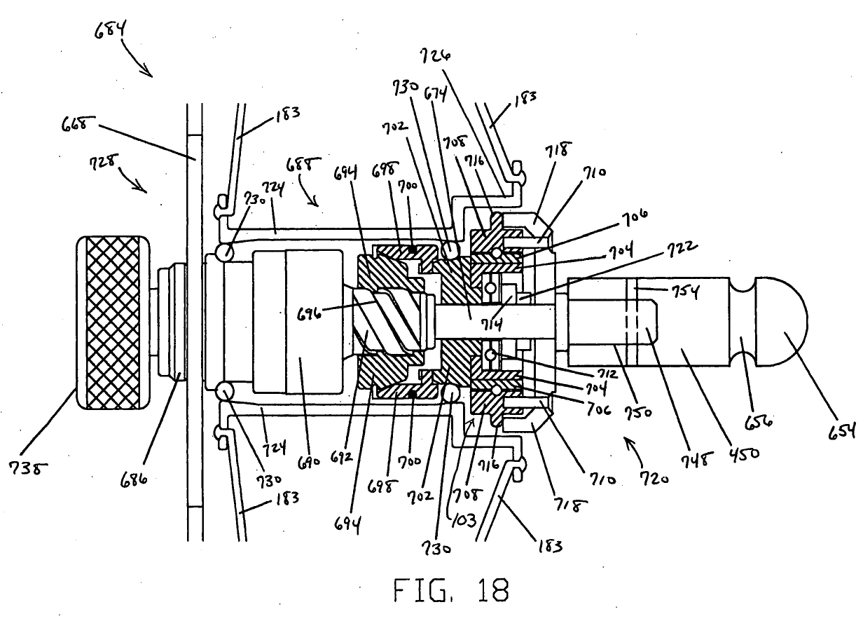

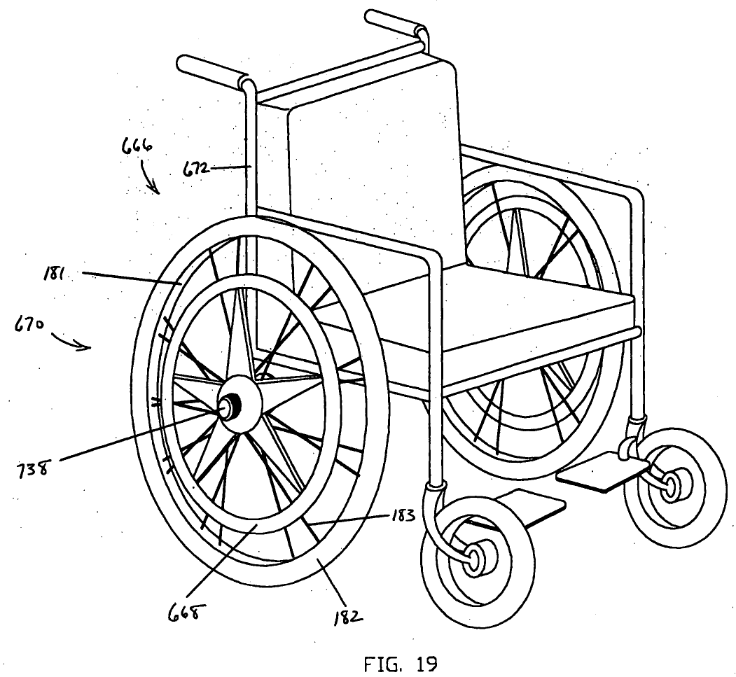

Referring now to FIGS. 17, 18 and 19, in another embodiment the propulsion system 666 includes a transmission having one or more hand-operable push rims 668, each including a coaster brake assembly 103 operably connected to a corresponding drive wheel assembly 670 for propulsion and braking of a hand powered vehicle 672 in a forward and reverse direction. The push rim 668 and the drive wheel assembly 670 are rotatably affixed about a cantilevered axle 674, which is attached to the vehicle frame 676.

Each drive wheel assembly 670 may include a rim 181, spokes 183, a tire 182, a wheel hub assembly 684 and a push rim 668.

Each front wheel hub assembly 684 includes a hub driver 686, a hub axle 674, a planetary gear core 690, a brake actuator 692, an inner brake cone 694, actuator threads 696, brake shoes 698, a brake shoe spring 700, an outer brake cone 702, brake cone extension 704, a freewheel bearing 716 with an inner race 706 and an outer race 708, retaining bolts 710, a thrust bearing 712, an inner axle nut 714, a freewheel bearing cover 718, an outer axle nut 722, a hub shell 724, a hub shell extension 726, driver ball bearings 730, brake cone ball bearings 732, and a gear selector assembly 734. In some embodiments, the coaster brake assembly 103 is sized and configured for containment within the hub shell 724.

The gear selector assembly 734 includes a gear selector body 736, a gear selector cap 738, a ball-nose spring plunger 740, a push rod 742 and a push rod adjuster 744.

The push rim 668 is attached to the hub driver 686 and functions as a hand-operable crank. The hub driver 686 rotates about the hub axle 674 and engages the planetary gear core 690 of an internal gear coaster brake hub 688. For example, a Shimano Nexus Inter3 Model No. SG-3C41 Internal Gear Coaster Brake Hub can be used. Affixed to the planetary gear core 690 is the brake actuator 692 that rotates about the hub axle 674. The inner brake cone 694 is positioned about the brake actuator 692 and engages helical block threads of the actuator 696. The brake shoes 698 are positioned about the inner brake cone 694. The brake shoes 698 are held in a compressed position by the brake shoe spring 700. The brake shoes 698 are engaged with the outer brake cone 702 such that the position of the brake shoes 698 relative to the position of the outer brake cone 702 remains constant. The outer brake cone 702 is attached to the brake cone extension 704. The brake cone extension 704 is attached to the inner race 706 of the freewheel bearing 716. The outer race 708 of the freewheel bearing is attached to the freewheel bearing cover 718 with retaining bolts 710. The thrust bearing 712 is located about the hub axle 674 and within the cavity defined by the freewheel bearing inner race 706, positioned between the brake cone extension 704 and the inner axle nut 714. The freewheel bearing 716 is located about the hub axle 674 and within the hub shell extension 726. On the coaster brake side 720 of the multi-gear hub, the hub axle 674 penetrates the freewheel bearing cover 718. Driver ball bearings 730 are located between the hub shell 724 and the hub driver 686 on the driver side 728 of the hub. Brake cone ball bearings 732 are located between the hub shell 724 and the outer brake cone 702 on the coaster brake side 720 of the hub.

The first end 746 of the hub axle that supports the drive wheel assembly 670 is a square or hexagonal boss 748, which is received by a corresponding square or hexagonal socket 750 within the frame mounting pin 752 on the axle side of the mounting pin 752. The square or hexagonal boss 748 is affixed to the square or hexagonal frame mounting pin 752 with a hardened spring pin 754 or dowel pin. The frame mounting pin 752 is affixed to a square or hexagonal receiver 755, which is integral to the vehicle frame 676. This method of affixing the hub axle 674 to the frame mounting pin 752 and affixing the frame mounting pin 752 to the receiver 755 integral to the vehicle frame 767 prevents the rotation of the hub axle 674.

The gear selector assembly 734 is attached to the multi-gear coaster brake hub axle 674 on the driver side 728 of the multi-gear hub, and is manually operable to shift gear engagements within the multi-gear hub 688. Gear selector 734 operates in the same manner as gear selector 166 of FIG. 4, discussed above.

Referring now to FIGS. 4, 17, 18 and 19, and in operation, the rider rotates the push rim 668 in a forward direction to propel the vehicle 672 forward. With the vehicle 672 in a stationary position, the rider rotates the push rim 668 in a rearward direction to propel the vehicle 672 rearward. With the vehicle 672 moving in a forward direction, the rider rotates the push rim 668 in a rearward direction to slow down and brake the vehicle 672. With the vehicle 672 moving in a rearward direction, the rider rotates the push rim 668 in a forward direction to slow down and stop the rearward movement of the vehicle 672. In this way, rotating the push rim 668 in a direction opposite to vehicle motion provides an intuitive means of slowing the vehicle 672.

The forward rotation of the push rim 668 rotates the multi-gear hub driver 686, which rotates the planetary gear core 690, which rotates the hub shell 724 at a selected ratio with respect to the hub driver 686. Rotation of hub shell 724 rotates the drive wheel assembly 670, which propels the vehicle 672 forward.

The rider can choose the desired drive gear of the multi-gear hub 688 using the gear selector 738 while the vehicle 672 is stationary or moving forward. In operation, the gear selector 738 is rotated in a clockwise or a counter-clockwise direction to select the desired gear ratio. When the gear selector 738 is rotated in a clockwise direction, the internal push rod (not shown) causes the planetary gear core 690 to move into a higher gear. The gear selector assembly 734 is described above and is illustrated in FIG. 4.

When the vehicle is in a stationary position, rearward rotation of the push rim 668 rotates the multi-gear hub driver 686, which rotates the planetary gear core 690 in a reverse direction, which causes the brake actuator 692 to rotate in a reverse direction, which causes the inner brake cone 694 to travel on the actuator threads 696 toward the outer brake cone 702, which causes the inner brake cone 694 to engage the brake shoes 698, which causes the brake shoes 698 to expand and to engage the hub shell 724, which causes the hub shell 724 to rotate in a reverse direction. The outer brake cone 702 is engaged with the brake shoes 698 and therefore also rotates in a reverse direction. This reverse rotation of the outer brake cone 702 is possible because the outer brake cone 702 is affixed to the brake cone extension 704, which is affixed to the inner race 706 of the freewheel bearing 716, which rotates within the outer race 708 of the freewheel bearing, which is affixed to the freewheel bearing cover 718, which is affixed to the supported end of the axle 674. When the hub shell 724 rotates in a reverse direction, the front drive wheel assembly 670 rotates in a reverse direction, which drives the vehicle in a rearward direction.

When the vehicle is moving forward, a partial rearward rotation of the push rim 668 rotates the hub driver 686 in a reverse direction, which causes the planetary gear core 690 to rotate in a reverse direction, which causes the brake actuator 692 to rotate in a reverse direction, which causes the inner brake cone 694 to travel longitudinally on the actuator threads 696 toward the outer brake cone 702, which causes the inner brake cone 694 to engage the brake shoes 698, which causes the brake shoes 698 to expand and to engage the hub shell 724, which introduces resistance to the forward rotation of the hub shell 724. This resistance is transferred from the hub shell 724 to the drive wheel assembly 670, which causes the vehicle to slow down or come to a complete stop. In this example, the freewheel bearing 716 prevents the outer brake cone 702 from rotating in a forward direction, which prevents the brake shoes 698 from rotating in a forward direction, which prevents the hub shell 724 from rotating in a forward direction, which prevents the planetary gear core 690 from rotating in a forward direction, which prevents the hub driver 686 from rotating in a forward direction, which prevents the push rim 668 from being driven in a forward direction.

It can be further noted that when the operator initiates a transition from moving the vehicle in a reverse direction to moving in a forward direction, the freewheel bearing 716 in combination with the brake cone extension 704 prevents the outer brake cone 702 from rotating. In this example, the forward rotation of the brake actuator 692 causes the inner brake cone 694 to slide longitudinally along the actuator threads 696 toward the planetary gear core 690, causing the inner brake cone 694 to disengage from the brake shoes 698, which causes the brake shoe spring 700 to return the brake shoes 698 to a compressed position, which causes the brake shoes 698 to disengage from the hub shell 724.

This allows the rider to propel forward in a forward direction with a selected gear ratio, freewheel in a forward direction by discontinuing rotation of the push rim 668, brake the vehicle while moving in the forward direction with a partial rotation of the push rim 668 in a reverse direction, rotate the push rim 668 in a reverse direction for rearward propulsion of the vehicle, and brake the vehicle while moving in a rearward direction by rotating the push rim 668 in a forward direction. All of the aforementioned actions are possible while the operator maintains full, uninterrupted contact with the push rim 668.

A hand-activated rear wheel brake (not shown) may also be provided for slowing or stopping the human powered vehicle. This may be a band brake, a caliper brake, a disc brake or a drum brake, for example.

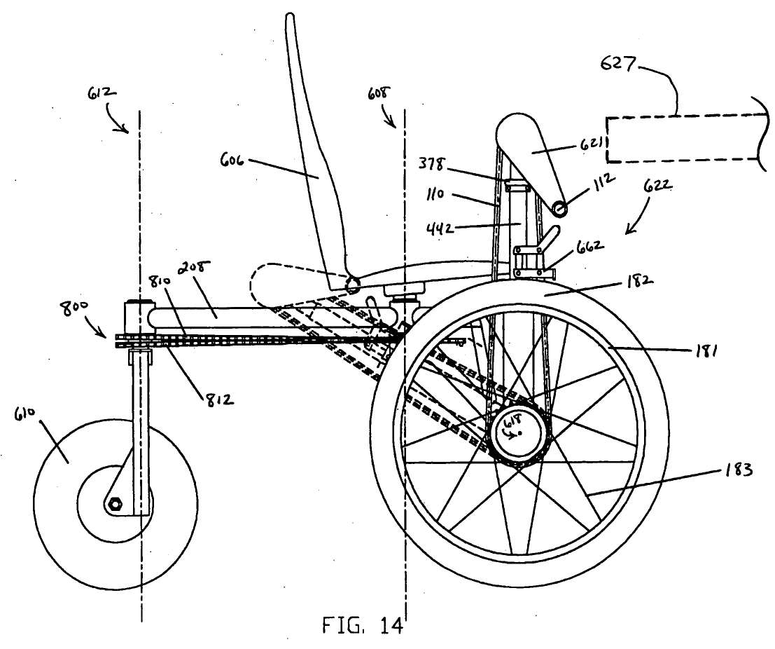

Referring now to FIGS. 14 and 22, a rear wheel driven sprocket assembly 800 may be mounted upon a rear fork steering tube 802 of the vehicle to provide steering of the rear wheel, as described in U.S. Pat. No. 6,902,177. The rear wheel driven sprocket assembly 800 includes an upper sprocket 806 and a lower sprocket 808 of equal diameter. The upper sprocket 806 and lower sprocket 808 are positioned about the fork steerer tube 802 to allow the upper chain 810 to rotate freely without contacting the opposing lower chain 812.

In this embodiment, the upper chain 810 wraps approximately two hundred degrees around the upper sprocket 806 in a first direction and terminates at the upper pin 814, affixing the upper chain 810 to the upper sprocket 806. The lower chain 812 wraps approximately two hundred degrees around the lower sprocket 808 in a second direction and terminates at the lower pin 816, affixing the lower chain 812 to the lower sprocket 808. In operation, the rear wheel steering driven sprocket assembly 800 rotates about the substantially vertical axis 612 of the rear fork steering tube 802.

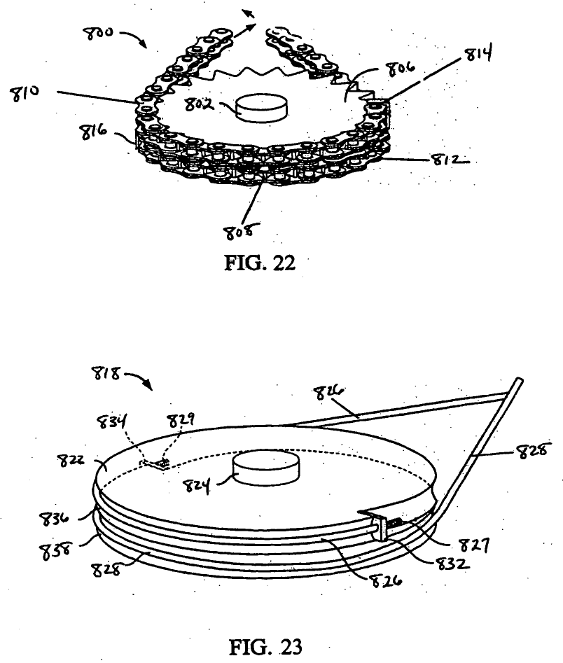

Alternatively, cogs, pulleys, chains or cables may be employed. For example, FIG. 23 shows a seat steering drive sprocket assembly 818 that may be rotatably attached to the frame of a human powered vehicle. The seat steering drive sprocket assembly 818 includes a double-groove pulley 822, a hub 824, an upper cable 826 with a first swaged threaded end 827, a lower cable 828 with a second swaged threaded end 829, an upper cable stop 832, a lower cable stop 834, and upper and lower adjusting nuts (not shown).

The upper groove 836 and the lower groove 838 of the pulley 822 are positioned to allow the upper cable 826 to rotate freely without contacting the opposing lower cable 828. The upper cable 826 wraps approximately two hundred degrees around the upper groove 836 of the pulley 822 in a first direction and passes through the upper cable stop 832, which is affixed to the pulley 822. The lower cable 828 wraps approximately two hundred degrees around the lower groove of the pulley 838 in a second direction and passes through the lower cable stop 834, which is affixed to the pulley 822. An upper adjusting nut (not shown) is threadably attached to the swaged threaded end of the upper cable 826. A lower adjusting nut (not shown) is threadably attached to the swaged threaded end of the lower cable 828. The upper cable 826 and the lower cable 830 are adjusted by the clockwise or counterclockwise rotation of the adjusting nuts (not shown) about the swaged threaded ends of the upper cable 826 and the lower cable 830. In operation, the seat steering drive sprocket assembly 818 rotates about a substantially vertical axis 608.

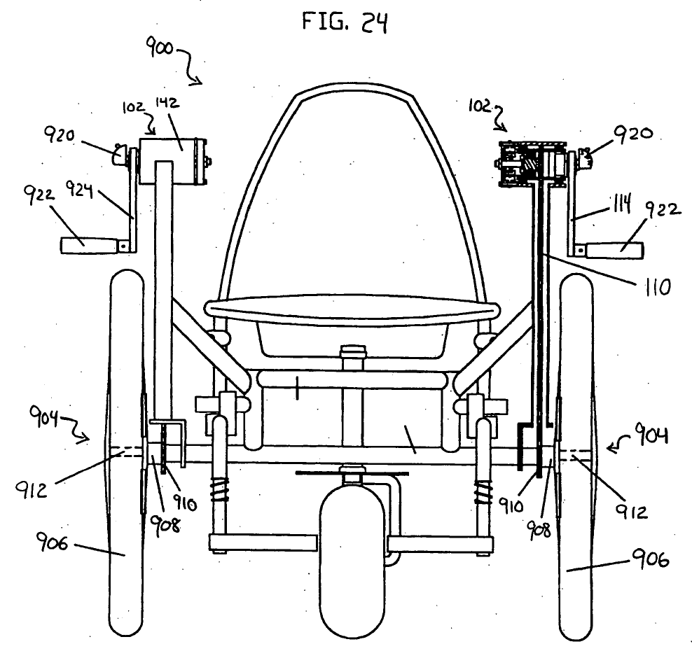

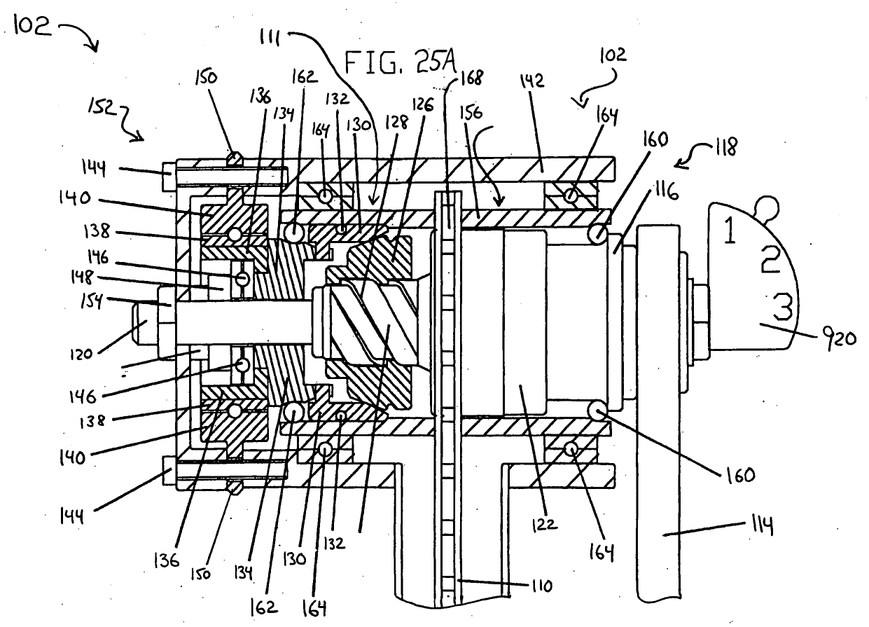

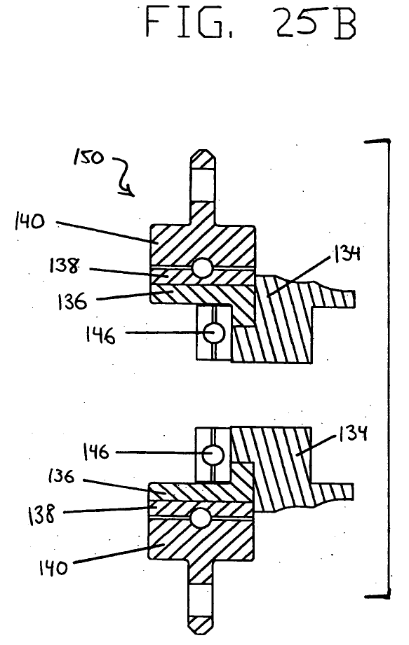

Referring now to FIGS. 24, 25A and 25B and in another embodiment, the vehicle 900 includes two independent hand-operable multiple-gear crank assemblies 102. The hand-operable multi-gear crank assemblies 102 include all of the components as described with respect to FIG. 3 except the gear selector assembly 166 is replaced with a gear selector 920. Each independent multiple-gear crank assembly 102 is operably connected to a corresponding front drive wheel assembly 904 for propulsion and braking of the vehicle 900 in a forward and reverse direction. The front drive wheel assembly 904 can include the front wheel 906, the wheel hub 908, the driven sprocket 910 and the wheel hub axle 912.

The gear selector 920 is attached to the multi-gear coaster brake hub axle 120 (FIG. 25A) on the driver side 118 of the multi-gear hub 156, and is manually operable to move an internal push rod (not shown) to shift gear engagements within the multi-gear hub. The rider can choose the desired drive gear of the multi-gear hub 156 using the gear selector 920 while the vehicle 900 is stationary or moving in a forward or reverse direction.

The hand-operable multi-gear crank assemblies 102 are driven by crank handles 922, connected to the hub driver 116 by crank arms 114. Rotation of the crank arm 114 in a first direction rotates the hub shell drive sprocket 168 (FIG. 25A), which drives a chain 110, which rotates the driven sprocket 910, which in turn, drives the corresponding front wheel 906, propelling the vehicle 900 in a forward direction. Rotation of the crank arm 114 in a second direction rotates the hub shell drive sprocket 168 (FIG. 25A), which drives a chain 110, which rotates the driven sprocket 910 in a second direction, which in turn, drives the corresponding front wheel 906, propelling the vehicle 900 in a reverse direction.

In operation, this embodiment operates identically to the first embodiment of the detailed description illustrated by FIG. 3, with the exception noted above regarding the gear selector.

This allows the rider to propel the vehicle 900 in a forward direction with a selected gear ratio by rotating the crank handles 922 in a forward direction, freewheel in a forward direction by discontinuing crank rotation, brake the vehicle 900 while moving in the forward direction by partial rotation of the crank handles 922 in a reverse direction, propel the vehicle 900 rearward by rotating the crank handles 922 in a reverse direction, and brake the vehicle 900 while moving in a rearward direction by rotating the crank handles 922 in a forward direction. All of the aforementioned actions are performed while the operator maintains full, uninterrupted contact with the crank handles 922.

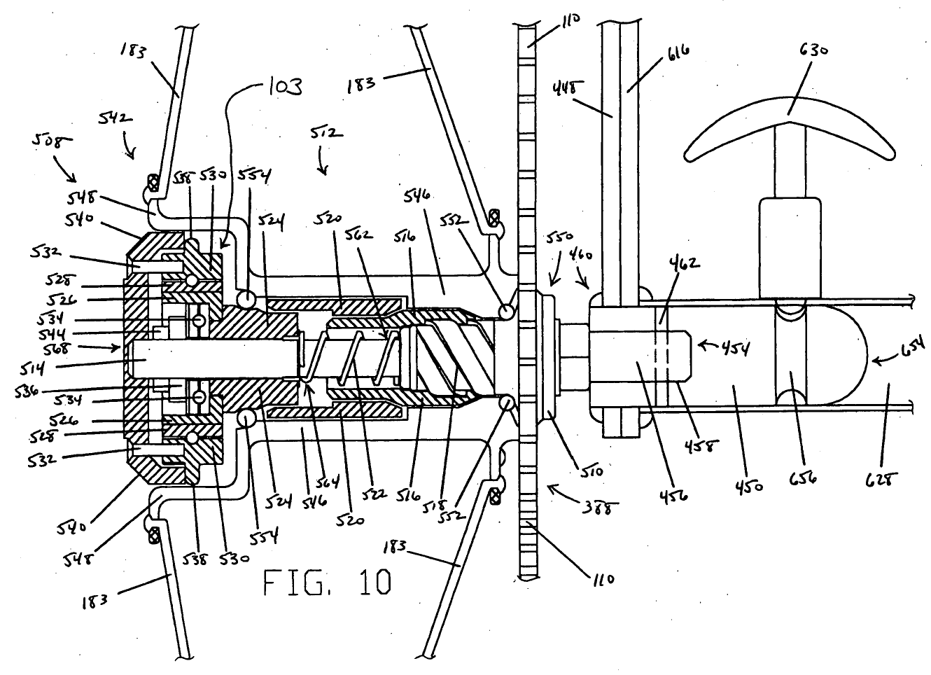

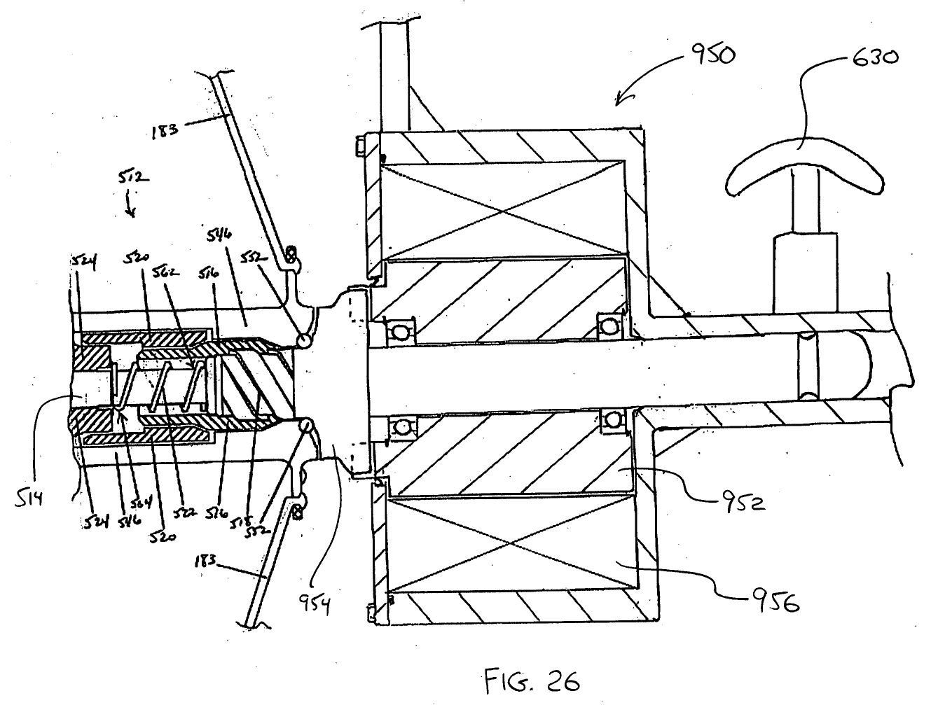

The in-hub transmissions described above are also useful in other types of vehicles. For example, FIG. 26 shows a portion of a single-speed cantilevered wheel hub 512 (as discussed above with respect to FIG. 10), but with an electric motor 950 disposed about the inner end of the axle 514 and having a rotatable armature 952 keyed to the inner face of a hub driver, to rotate the hub driver 954 about the axle. A stator 956 of the motor is secured within the vehicle frame, and the spring loaded retractable plunger 630 retains the axle and allows for a quick release of the axle and wheel as an assembly. The arrangement shown in FIG. 26 may be provided in a motorized wheelchair, with either one or two driven wheels. Because the hub configuration mechanically provides the functions of bi-directional propulsion, braking and coasting, the electric motor need only be controlled to generate the torques necessary for such functions. Such torque control may be accomplished by controlling current, without the need for positional feedback. In a wheelchair or assisted mobility vehicle, a joystick control (not shown) may be provided, with current and torque controlled as a function of joystick direction and displacement. Joystick operation is simplified further when steering is provided by seat rotation, as described above.

This transmission hub arrangement can greatly simplify motor control and reduce power consumption. Rolling forward downhill, for example, the operator need only pull back slightly on the joystick to apply a reverse motor torque to engage the brake shoes 520 for braking, but can otherwise allow the vehicle to coast by releasing the joystick.

A number of embodiments have been described. Other embodiments are within the scope of the following claims.

### REFERENCE NUMBERS LIST

100 Propulsion system with multi-gear transmission in hand crank assembly

102 Multi-gear crank assemblies

103 Coaster brake assembly

104 Front drive wheel assembly

106 Vehicle

108 Propulsion tower assembly

110 Roller chain

112 Crank handle

114 Crank arm

116 Hub driver

118 Multi-gear coaster brake bicycle hub

120 Hub axle

122 Planetary gear core

124 Brake actuator

126 Inner brake cone

128 Actuator threads

130 Brake shoes

132 Brake shoes spring

134 Outer brake cone

136 Outer brake cone extension

138 Inner race of freewheel bearing

140 Outer race of freewheel bearing

142 Crank Hub housing

144 Retaining bolts

146 Thrust bearing

148 Inner axle nut

150 Freewheel bearing

152 Coaster brake side of hub

154 Outer axle nut

156 Hub shell (upper)

158 Driver side of hub

160 Driver ball bearing retainer

162 Brake cone ball bearing retainer

164 Hub housing bearing assemblies

165 Vertical slot

166 Gear selector assembly

168 Drive sprocket

170 Gear selector body

172 Gear selector cap

174 Ball nose spring plunger

176 Push rod

178 Push rod adjuster

180 Front wheel

181 Rim

182 Tire

183 Spokes

184 Wheel hub

185 Driven Sprocket

186 Wheel hub axle

190 Internal threads gear selector body

194 Crank arm side of multi-speed hub

196 High helix thread

198 Detents

200 Internal threads gear selector cap

202 Push rod first end

204 Push rod second end

206 Threaded hole (end wall)

208 Vehicle frame

210 Gear selector

250 Propulsion system for Single Speed Transmission in Hand Crank Assembly

252 Hand crank assembly single speed

258 Propulsion tower assembly

264 Crank arm

266 Hub driver

267 Driver side axle nut

268 Modified internal gear bicycle hub

270 Hand Crank Hub axle

272 Clutch cone

274 Hub driver threads

276 Brake shoes

278 Clutch cone spring

280 Brake cone

282 Brake cone extension

284 Inner race of freewheel

286 Outer race of freewheel

288 Hub housing

289 Freewheel bearing cover

290 Retaining Bolts

292 Thrust bearing

294 Inner axle nut

296 Freewheel bearing

298 Coaster brake side of hub

300 Outer axle nut

302 Hub shell

304 Driver side of hub

306 Driver ball bearing retainer

308 Brake cone ball bearing retainer

310 Hub housing bearing assemblies

312 Drive sprocket

324 Clutch cone first end

326 Clutch cone second end

350 Propulsion system with multi-gear transmission in wheel hub

352 Hand crank assembly

354 Front drive wheel assembly

356 Propulsion tower assembly

358 Crank arm

360 Crank arm mounting plate

361 mounting plate screws

362 Keyed shaft

363 keyed shaft first end

364 Woodruff key

366 Inner bearing

368 Outer bearing

369 keyed shaft second end

370 Drive sprocket

372 Crank housing

374 Shaft retaining nut

376 Threaded mounting post

378 Chain tension adjuster

386 Wheel hub assembly

388 Driven sprocket

390 Hub driver

392 Multi gear internal bicycle hub

394 Hub axle

396 Planetary gear core

398 Brake actuator

400 Inner brake cone

402 Actuator threads

404 Brake shoes

406 Brake shoe spring

408 Outer brake cone

410 Brake cone extension

412 Inner race of freewheel bearing

414 Outer race of freewheel bearing

416 Retaining bolts

418 Thrust bearing

420 Inner axle nut

422 Freewheel bearing

424 Freewheel bearing cover

426 Coaster brake side of hub

428 Outer axle nut

430 Hub shell

432 Hub shell extension

434 Driver side of hub

436 Driver ball bearings

438 Brake cone ball bearings

440 Gear shifter

442 Vertical receiver tube

444 Upper end of vertical tube

446 Collar clamp

448 Tower plate

450 Horizontal tower mounting pin

454 Hub axle on first end (supporting end)

456 Square boss

458 Square socket

460 Axle side of mounting pin (first end)

462 Spring pin

464 Gear selector

466 Unsupported end of axle

500 Propulsion System with single speed transmission in wheel hub

504 Front wheel drive assembly

508 Wheel hub assembly

510 Hub driver

512 Single speed internal bicycle hub

514 Hub axle

516 Clutch cone

518 Hub driver threads

520 Brake shoes

522 Clutch cone spring

524 Brake cone

526 Brake cone extension

528 Inner race of freewheel bearing

530 Outer race of freewheel bearing

532 Retaining bolts

534 Thrust bearing

536 Inner axle nut

538 Freewheel bearing

540 Freewheel bearing cover

542 Coaster brake side of hub

544 Outer axle nut

546 Hub shell

548 Hub shell extension

550 Driver side of hub

552 Driver ball bearing retainer

554 Brake cone ball bearing retainer

556 First end of keyed shaft

558 Second end of keyed shaft

560 Helical threads

562 Clutch cone first end

564 Clutch cone second end

566 Retaining bolts (freewheel cover)

568 Axle end

602 Front wheels

604 Forward portion of frame

606 Seat

608 Seat pivot axis

610 Rear wheel

612 Rear wheel king pin axis

614 Frame receiver tube

615 Lower attachment point

616 Tower adjustment plate

617 Upper attachment point

618 Pivot axis

620 Hand crank assembly

621 Crank arm

622 Propulsion tower assembly

623 Crank housing

624 Front drive wheel assembly

625 Wheel hub

626 Adjustable clamping handle

628 Propulsion tower pin receiver

630 Spring loaded plunger

632 Upper end of tower assembly

634 Lower end of tower assembly

636 Vehicle Frame forward position

638 Threaded portion propulsion tower assembly

640 Curved slot

642 Lower horizontal frame tube

654 Tapered end of mounting pin

656 Circumferential groove

658 Engaged position (plunger)

660 Disengaged position (plunger)

662 Wheelchair locking brake

666 Propulsion system with hand crank comprising push rim

668 Push rim

670 Drive wheel assembly

672 Vehicle-wheelchair

674 Cantilever axle

676 Vehicle frame

684 Wheel hub assembly

686 Hub driver

688 Multi gear coaster brake bicycle hub

690 Planetary gear core

692 Brake actuator

694 Inner brake cone

696 Helical Actuator threads

698 Brake shoes

700 Brake shoe spring

702 Outer brake cone

704 Brake cone extension

706 Inner race of freewheel bearing

708 Outer race of freewheel bearing

710 retaining bolts

712 thrust bearing

714 Inner axle nut

716 Freewheel bearing

718 Freewheel bearing cover

720 Coaster brake side of hub

722 Outer axle nut

724 Hub shell

726 Hub shell extension

728 Driver side of hub

730 Driver ball bearings

732 Brake cone ball bearings

734 Gear selector assembly

736 Gear selector body

738 Gear selector cap

740 Ball nose spring plunger

742 Push rod

744 Push rod adjuster

746 Hub axle first end (supporting)

748 Square boss

750 Square socket

752 Frame mounting pin first side

754 Spring pin

755 Square receiver

756 High helix threads (gear selector body)

758 Detent

760 Internal threads of cap

762 First end push rod

764 Second end push rod

766 Threaded hole

800 Rear wheel driven sprocket assembly

802 Rear fork steering tube

806 Upper sprocket

808 Lower sprocket

810 Upper chain

812 Lower chain

814 Upper pin

816 Lower pin

818 Seat steering drive sprocket assembly

822 Double groove pulley

824 Hub

826 Upper cable

827 First swaged threaded end

828 Lower cable

829 Second swaged threaded end

832 Upper cable stop

834 Lower cable stop

836 Upper groove

838 Lower groove

950 Electric motor

952 Rotatable armature

954 Hub driver

956 Stator

What is claimed is:

1. A human-powered vehicle comprising:
a structural frame;
a driven wheel mounted for rotation about an axle secured to a lower portion of the frame; the axle affixed to the frame on only one side of the wheel, such that the wheel has a cantilevered hub;
a hand-operable crank manually operable by an operator of the vehicle for vehicle propulsion; and
a transmission connecting the crank and wheel, such that motion of the crank is converted to a corresponding motion of the wheel;
wherein the wheel and crank are interconnected such that with the vehicle at rest, cranking motion of the crank in a first rotational direction propels the vehicle forward and cranking motion of the crank in a second rotational direction propels the vehicle backward, and such that, with the vehicle in forward motion, cessation of crank rotation allows free rotation of the wheel, and crank torque applied in a sense opposing forward vehicle motion applies a braking force to the wheel.

2. The vehicle of claim 1, wherein the transmission includes a coaster brake assembly contained within the cantilevered wheel hub.

3. The vehicle of claim 1, wherein the hand-operable crank is rotatable about an axis disposed above the driven wheel.

4. The vehicle of claim 3, wherein the transmission includes a coaster brake assembly disposed above the driven wheel and adjacent the crank.

5. The vehicle of claim 1, wherein the transmission provides multiple gear ratios for propulsion of the vehicle in a forward direction.

6. The vehicle of claim 5, wherein the transmission includes a planetary gear core disposed within a hub shell connected to the wheel, the gear core engaging the hub shell to drive the hub shell in mutual rotation in only one direction.

7. The vehicle of claim 1, wherein the hand-operable crank comprises a push rim disposed outboard of the driven wheel.

8. The vehicle of claim 1, comprising two hand-operable cranks operably connected to two corresponding driven wheels and independently and simultaneously operable for vehicle propulsion.

9. The vehicle of claim 1, further comprising a seat secured to the frame and positioned to enable the vehicle operator to manually operate the crank while seated in the seat.

10. The vehicle of claim 9, wherein the seat is rotatable and connected to a steerable wheel of the vehicle, such that seat rotation alters a steering angle of the steerable wheel.

11. The vehicle of claim 1, wherein the transmission includes
a brake shoe that bears against a surface of a rotatable transmission shell to drive the shell in one rotational direction for propulsion; and
a freewheel bearing that permits rotation of the brake shoe in said one rotational direction, and transfers braking loads while preventing rotation of the brake shoe in an opposite rotational direction.

12. The vehicle of claim 11, wherein the transmission further includes a brake cone that engages and deflects the brake shoe against the hub shell to rotate the hub shell and drive the wheel in one rotational direction, in response to an associated cranking motion of the crank with the vehicle at rest.

13. The vehicle of claim 11, wherein the brake shoe is disposed within the cantilevered wheel hub, and wherein the rotatable transmission shell comprises a portion of the wheel hub, the transmission further including a freewheel bearing cover that transfers the braking loads from the freewheel bearing to the axle.

14. The vehicle of claim 11, wherein the brake shoe is disposed within a transmission hub shell that rotates about an axis of rotation of the hand crank.

15. The vehicle of claim 14, wherein the axis of rotation of the hand crank is above the wheel.

16. The vehicle of claim 15, wherein the freewheel bearing has an inner race rotationally coupled to the brake shoe, and an outer race rotationally coupled to the frame.

17. A human-powered vehicle comprising:
a structural frame;
a driven wheel having a hub mounted for rotation about an axle secured to a lower portion of the frame;
a hand-operable crank rotatable about an axis disposed above the driven wheel and manually operable by an operator of the vehicle for vehicle propulsion;
a transmission connecting the crank and wheel, such that motion of the crank is converted to a corresponding motion of the wheel; and
a structural crank tower supporting the crank, the crank tower rotatable about the wheel axle and releasably securable to the frame to lock the tower in an upright position.

18. The vehicle of claim 17, wherein the crank tower is releasably securable to the frame in multiple rotational positions about the wheel axle.

19. The vehicle of claim 18, wherein the crank is operable to drive the wheel with the tower disposed in each of its multiple rotational positions.

20. The vehicle of claim 17, further comprising a seat secured to the frame and positioned to enable the vehicle operator to manually operate the crank while seated in the seat.

21. The vehicle of claim 20, wherein the crank tower is lowerable to a position lower than a seating surface of the seat.

22. The vehicle of claim 17, wherein the wheel, crank and crank tower are readily removable from the vehicle frame as a propulsion unit assembly, for vehicle storage.

23. The vehicle of claim 22, wherein the propulsion unit assembly is secured to the vehicle frame by a quick-release connector releasably securing the axle to the frame.

24. The vehicle of claim 17, wherein the wheel and crank are interconnected such that with the vehicle at rest, cranking motion of the crank in a first rotational direction propels the vehicle forward and cranking motion of the crank in a second rotational direction propels the vehicle backward, and such that, with the vehicle in forward motion, cessation of crank rotation allows free rotation of the wheel, and crank torque applied in a sense opposing forward vehicle motion applies a braking force to the wheel.

25. The vehicle of claim 17, wherein the axle is affixed at a single end such that the wheel has a cantilevered hub.

26. A vehicle comprising:
a structural frame;
a driven wheel having a hub mounted for rotation about an axle secured to a lower portion of the frame;
a brake shoe that bears against a surface of the wheel hub to drive the wheel in one rotational direction for vehicle propulsion;
a freewheel bearing that permits rotation of the brake shoe in said one rotational direction, and transfers braking loads to the frame while preventing rotation of the brake shoe in an opposite rotational direction; and
a hub driver rotatable to drive the wheel hub in a first rotational direction, and to drive the brake shoe into torque-carrying engagement with the wheel hub to drive the wheel hub in a second rotational direction;
wherein the axle is affixed to the frame on only one side of the wheel, such that the hub is cantilevered, and wherein the braking loads are transferred from the freewheel bearing to the frame through the axle.

27. The vehicle of claim 26, further comprising a hand-operable crank operably connected to the hub driver and manually operable by an operator of the vehicle for vehicle propulsion.

28. The vehicle of claim 26, further comprising an electric motor operably connected to the hub driver for vehicle propulsion.

29. The vehicle of claim 26, wherein the freewheel bearing and brake shoe are components of a coaster brake assembly connecting the hub driver to the hub such that with the vehicle at rest, rotation of the hub driver in a first rotational direction propels the vehicle forward and rotation of the hub driver in a second rotational direction propels the vehicle backward, and such that, with the vehicle in forward motion, cessation of hub driver rotation allows free rotation of the wheel, and hub driver torque applied in a sense opposing forward vehicle motion applies a braking force to the wheel.
